(19) United States
(12) Patent Application Publication
(10) Pub. No.: US 2026/0159231 A1
(43) Pub. Date: Jun. 11, 2026

(54) DECENTRALIZED LEARNING CONTROL FOR NONLINEAR AEROSPACE DYNAMICS

(71) Applicants: Brent Wallace, Phoenix, AZ (US); Jennie Si, Phoenix, AZ (US)

(72) Inventors: Brent Wallace, Phoenix, AZ (US); Jennie Si, Phoenix, AZ (US)

(73) Assignee: Arizona Board of Regents on Behalf of Arizona State University, Scottsdale, AZ (US)

(21) Appl. No.: 19/409,185

(22) Filed: Dec. 4, 2025

Related U.S. Application Data
(60) Provisional application No. 63/729,189, filed on Dec. 6, 2024.

(51) Int. Cl. B64C 19/00; B64C 30/00; G06N 20/00

(52) U.S. Cl. CPC B64C 19/00; B64C 30/00; G06N 20/00

(57) ABSTRACT

A method is presented for learning a control solution for a continuous-time affine-nonlinear aerospace system. The method includes decentralizing a control solution into lower dimensional control loops based on a partition of system dynamics, applying excitation signals comprising reference-command variations and probing inputs to increase persistence of excitation during learning, and performing a prescaling transformation of state variables to modify conditioning properties of a learning regression. Trajectory data are collected during operation under the excitation signals to generate learning data for the decentralized control loops. A reinforcement learning control process is trained using the learning data to obtain updated control parameters, which are then output as a learned control solution for the system.

### CLAIM OF PRIORITY

This application claims the benefit of U.S. Patent Application No. 63/729,189, filed 6 Dec. 2024, the entire contents of which is incorporated herein by reference.

### GOVERNMENT RIGHTS AND GOVERNMENT AGENCY SUPPORT NOTICE

This invention was made with government support under 1808752 and 2211740 awarded by the National Science Foundation. The government has certain rights in the invention.

### TECHNICAL FIELD

Aspects of the disclosure relate generally to control theory, machine learning, and artificial intelligence, and more particularly to techniques associated with learning-based control for dynamic systems.

### BACKGROUND

Hypersonic aerospace platforms operate under extreme aerodynamic, thermal, and structural conditions that significantly influence vehicle dynamics and control responses. These platforms encounter nonlinear airflow behavior, shock interactions, rapidly varying pressure fields, and material property changes that make control modeling and prediction challenging. Conventional control strategies often rely on simplified or approximate representations of vehicle dynamics, which may limit performance when confronted with strong coupling between translational and rotational motions or rapidly changing flight environments. Data-driven and learning-based techniques have been explored to complement traditional control frameworks, yet their effectiveness depends on the availability of informative excitation, well-conditioned learning formulations, and reliable methods for processing trajectory data.

### SUMMARY

In general, this disclosure describes techniques for learning a control solution for a continuous-time affine-nonlinear aerospace system through decentralized and data-driven operations. In certain examples, a control formulation may be partitioned into a set of lower dimensional control loops that correspond to different portions of system dynamics. Excitation signals, which may include reference-command variations and probing inputs, can be applied to the system to provide informative data for learning. A prescaling transformation of state variables may be performed to adjust conditioning characteristics of a learning regression associated with the decentralized loops, facilitating subsequent processing of collected trajectory data. The trajectory data obtained during operation under excitation can then be used to generate learning data for the control loops.

Additional examples relate to training a reinforcement learning control process using the learning data to determine updated control parameters that characterize the learned control solution. The trained control parameters may be output for use in controlling the aerospace system. In various implementations, the techniques may support operation across nonlinear or partitioned dynamic regimes, and may be applied alongside a variety of dynamic models, learning structures, or data-excitation configurations while maintaining decentralized processing across the control loops.

According to one example, a method for learning a control solution for a continuous-time affine-nonlinear aerospace system includes decentralizing a control solution for the system into a plurality of lower dimensional control loops based on a partition of system dynamics. In one example, the method includes applying excitation signals to the system, the excitation signals comprising reference-command variations and probing inputs configured to increase persistence of excitation during learning. According to such examples, the method includes selectively performing a prescaling transformation of state variables, the prescaling transformation configured to modify conditioning properties of a learning regression associated with the decentralized control loops. In at least one example, the method includes collecting trajectory data from operation of the system under the applied excitation signals and generating learning data for the decentralized control loops. In one example, the method includes training a reinforcement learning control process that performs integral value-function updates based on trajectory data using the learning data to obtain updated control parameters. According to such examples, the method includes outputting the updated control parameters as a learned control solution for the system.

According to another example, a system for learning a control solution for a continuous-time affine-nonlinear aerospace vehicle includes at least one memory configured to store instructions and processing circuitry configured to execute the instructions to decentralize a control solution for the vehicle into a plurality of lower dimensional control loops based on a partition of vehicle dynamics. In one example, the system includes processing circuitry configured to apply excitation signals to the vehicle, the excitation signals comprising reference-command variations and probing inputs configured to increase persistence of excitation during learning. According to such examples, the system includes processing circuitry configured to selectively perform a prescaling transformation of state variables, the prescaling transformation configured to modify conditioning properties of a learning regression associated with the decentralized control loops. In at least one example, the system includes processing circuitry configured to collect trajectory data from operation of the vehicle under the applied excitation signals and generate learning data for the decentralized control loops. In one example, the system includes processing circuitry configured to train a reinforcement learning control process that performs integral value-function updates based on trajectory data using the learning data to obtain updated control parameters. According to such examples, the system includes processing circuitry configured to output the updated control parameters as a learned control solution for the vehicle.

According to yet another example, a non-transitory computer-readable medium stores instructions that, when executed by processing circuitry, cause the processing circuitry to decentralize a control solution for a continuous-time affine-nonlinear aerospace vehicle into a plurality of lower dimensional control loops based on a partition of system dynamics. In one example, the non-transitory computer-readable medium stores instructions that cause the processing circuitry to apply excitation signals to the vehicle comprising reference-command variations and probing inputs configured to increase persistence of excitation during learning. According to such examples, the non-transitory computer-readable medium stores instructions that cause the processing circuitry to perform a prescaling transformation of state variables to modify conditioning properties of a learning regression. In at least one example, the non-transitory computer-readable medium stores instructions that cause the processing circuitry to collect trajectory data and generate learning data for the decentralized control loops. In one example, the non-transitory computer-readable medium stores instructions that cause the processing circuitry to train a reinforcement learning control process that performs integral value-function updates based on trajectory data using the learning data to obtain updated control parameters. According to such examples, the non-transitory computer-readable medium stores instructions that cause the processing circuitry to output the updated control parameters as a learned control solution for the vehicle.

According to a particular example, there is a device which includes means for decentralizing a control solution for a continuous-time affine-nonlinear aerospace system into a plurality of lower dimensional control loops based on a partition of system dynamics. In one example, the device includes means for applying excitation signals to the system, the excitation signals comprising reference-command variations and probing inputs configured to increase persistence of excitation during learning. According to such examples, the device includes means for selectively performing a prescaling transformation of state variables, the prescaling transformation configured to modify conditioning properties of a learning regression associated with the decentralized control loops. In at least one example, the device includes means for collecting trajectory data from operation of the system under the applied excitation signals and means for generating learning data for the decentralized control loops. In one example, the device includes means for training a reinforcement learning control process that performs integral value-function updates based on trajectory data using the learning data to obtain updated control parameters. According to such examples, the device includes means for outputting the updated control parameters as a learned control solution for the system.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating further details of one example of computing device, in accordance with aspects of this disclosure.

FIGS. 2A and 2B depict the Z/P ratio and controllability matrix conditioning of a hypersonic vehicle, in accordance with aspects of the disclosure.

FIG. 3 depicts a hierarchical inner-outer loop feedback structure, in accordance with aspects of the disclosure.

FIG. 4 depicts Table 1 summarizing closed-loop performance metrics, in accordance with aspects of the disclosure.

FIG. 5 depicts Table 2, which is presented beneath performance maps, in accordance with aspects of the disclosure.

FIGS. 6A, 6B, and 6C depict charts showing sensitivity and complementary sensitivity frequency responses at the error with respect to variations in the pitch moment modeling error of Equation (8), in accordance with aspects of the disclosure.

FIG. 7 depicts Table 3, summarizing step-response performance metrics versus modeling error ν for compared methods, in accordance with aspects of the disclosure.

FIGS. 8A, 8B, 8C, 8D, 8E, and 8F depict closed-loop responses to a step flight-path-angle (FPA) command, in accordance with aspects of the disclosure.

FIG. 9 depicts Table 4 summarizing the dEIRL optimality error and conditioning data due to ablations of initial condition x₀, in accordance with aspects of the disclosure.

FIGS. 10A, 10B, 10C, 10D, 10E, and 10F depict charts showing the dEIRL controller optimality error

$$‖ {K}_{{i}^{*} , 2} - {K}_{2}^{*} ‖$$

and worst conditioning

$${max}_{i} κ ( {A}_{i , 2} )$$

versus IC x₀ and varying modeling error, in accordance with aspects of the disclosure.

FIGS. 11A, 11B, and 11C depict charts showing nominal model closed-loop response to step velocity command, in accordance with aspects of the disclosure.

FIG. 12 depicts Table 5 summarizing the dEIRL optimality error and conditioning data due to ablations of modeling error ν, in accordance with aspects of the disclosure.

FIGS. 13A, 13B, 13C, 13D, 13E, and 13F depict charts showing the dEIRL controller optimality error

$$‖ {K}_{{i}^{*} , 1} - {K}_{1}^{*} ‖$$

and worst conditioning

$${max}_{i} κ ( {A}_{i , 1} )$$

for various simultaneous modeling errors, in accordance with aspects of the disclosure.

FIGS. 14A and 14B depict closed-loop performance metrics failure percentage, in accordance with aspects of the disclosure.

FIGS. 15A and 15B depict the dEIRL iterationwise maximum algorithm condition number

$${max}_{i} κ ( {A}_{i , j} )$$

for 10,000 trials of randomly distributed modeling error, in accordance with aspects of the disclosure.

FIG. 16 is a flow diagram illustrating an example method for learning a control solution for a continuous-time affine-nonlinear aerospace system, in accordance with aspects of this disclosure.

### DETAILED DESCRIPTION

In general, this disclosure describes techniques for learning a control solution for a continuous-time affine-nonlinear aerospace system through decentralized and data-driven operations. In certain examples, a control formulation may be partitioned into a set of lower dimensional control loops that correspond to different portions of system dynamics. Excitation signals, which may include reference-command variations and probing inputs, can be applied to the system to provide informative data for learning. A prescaling transformation of state variables may be performed to adjust conditioning characteristics of a learning regression associated with the decentralized loops, facilitating subsequent processing of collected trajectory data. The trajectory data obtained during operation under excitation can then be used to generate learning data for the control loops.

Additional examples relate to training a reinforcement learning control process using the learning data to determine updated control parameters that characterize the learned control solution. The trained control parameters may be output for use in controlling the aerospace system. In various implementations, the techniques may support operation across nonlinear or partitioned dynamic regimes, and may be applied alongside a variety of dynamic models, learning structures, or data-excitation configurations while maintaining decentralized processing across the control loops.

Continuous-time reinforcement learning methodologies span a range of adaptive and data-driven control formulations applicable to dynamic systems. Within this area, adaptive dynamic programming approaches have been developed to iteratively approximate value functions or policies for control objectives. These approaches emphasize optimization in continuous time and may support decision-making in environments characterized by nonlinear dynamics and continuously evolving system states. Although these techniques show strong theoretical development, their application to realistic aerospace control scenarios often requires consideration of model complexity, interaction between translational and rotational dynamics, and operational uncertainty.

Reinforcement learning frameworks for aerospace vehicles, including those exhibiting nonlinear or nonminimum phase behavior, commonly employ reduced-order models or simplified assumptions to remain tractable. Such simplifications can limit applicability when confronted with dynamic pressure variations, coupled aerodynamic effects, or actuator limits that arise in high-performance or high-speed flight regimes. Approaches leveraging decentralized formulations, excitation strategies, and prescaling transformations may be applied within these contexts to support learning processes that operate across interconnected dynamic components of the system.

Examples that incorporate structured excitation, decentralized loop organization, and data-driven learning updates may be utilized to address cases where analytical models are incomplete or where simulation and numerical evaluation are relied upon to inform control development. These examples may be applied in evaluating learning behavior, examining convergence properties, or assessing control performance over a range of initial conditions, disturbances, or modeling uncertainties.

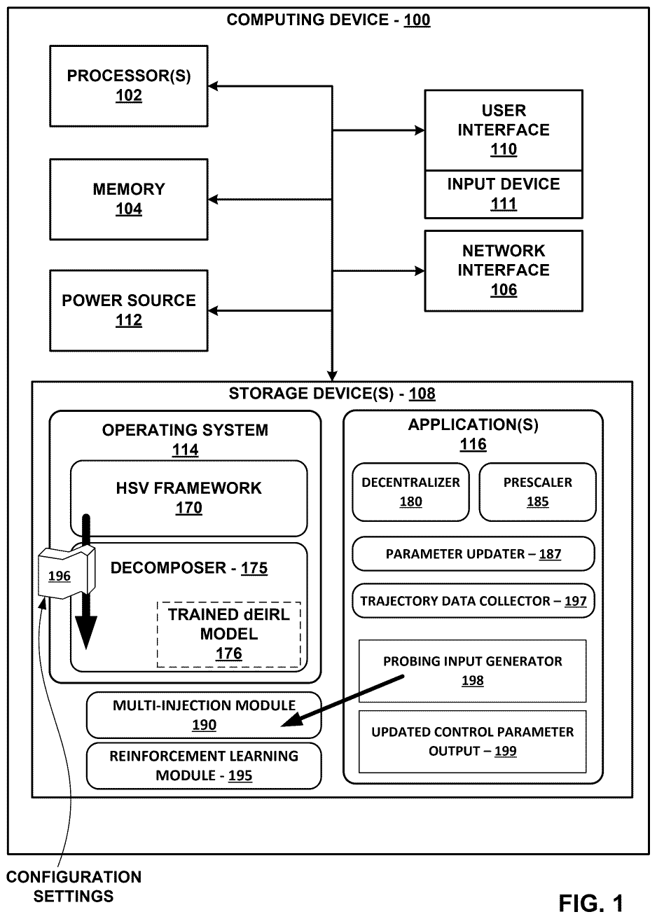

FIG. 1 is a block diagram illustrating further details of one example of computing device 100, in accordance with aspects of this disclosure. FIG. 1 illustrates one possible configuration of computing device 100, and other configurations may be used. Computing device 100 includes processor(s) 102, memory 104, network interface 106, storage device(s) 108, user interface 110, input device 111, and power source 112. Computing device 100 also includes operating system 114 stored within storage device(s) 108. Application(s) 116 stored within storage device(s) 108 may include decentralizer 180, prescaler 185, parameter updater 187, trajectory data collector 197, probing input generator 198, multi-injection module 190, reinforcement learning module 195, and updated control parameter output 199. Storage device(s) 108 further store hypersonic vehicle (HSV) framework 170, decomposer 175, trained decentralized excitable integral reinforcement learning (dEIRL) model 176, and configuration settings 196.

Operating system 114 executes functions of HSV framework 170 together with decentralizer 180, prescaler 185, trajectory data collector 197, probing input generator 198, multi-injection module 190, parameter updater 187, and reinforcement learning module 195. Decomposer 175 receives configuration settings 196 and produces decentralized control representations that correspond to lower dimensional control loops derived from translational and rotational dynamics of hypersonic vehicles. Trained dEIRL model 176 contains control parameters derived from iterative learning processes and may be adjusted through configuration settings 196.

Processor(s) 102 perform operations for computing device 100. Processor(s) 102 may execute instructions stored in memory 104 or stored in storage device(s) 108. Processor(s) 102 may include general-purpose processors, central processing units (CPU), graphics processing units (GPU), digital signal processors (DSP), or other programmable logic configured to carry out control-related computations, learning updates, data transformations, and communication tasks.

Memory 104 stores information during operation of computing device 100. Memory 104 may include volatile storage elements such as random access memory (RAM), dynamic random-access memory (DRAM), static random-access memory (SRAM), or other temporary computer-readable storage media. Memory 104 may store program instructions for execution by processor(s) 102 and may store interim results produced by application(s) 116 while performing processes such as collecting trajectory data, generating probing signals, computing prescaling transformations, or updating reinforcement learning parameters.

Storage device(s) 108 provide long-term computer-readable storage media and may include magnetic hard disks, optical discs, Flash memory, electrically programmable read-only memory (EPROM), electrically erasable and programmable read-only memory (EEPROM), or other non-volatile storage technologies. Storage device(s) 108 maintain operating system 114, application(s) 116, HSV framework 170, decomposer 175, trained dEIRL model 176, and configuration settings 196. Storage device(s) 108 may also store historical trajectory logs, regression matrices, prescaling values, or archived control solutions used for model validation or reinforcement learning analysis.

Network interface 106 enables wired or wireless communication between computing device 100 and external systems such as servers, simulation platforms, autonomous vehicles, or remote monitoring stations. Network interface 106 may include Ethernet interfaces, optical transceivers, wireless communication modules, or combinations of these. Network interface 106 may exchange control parameters, trajectory datasets, configuration files, or remote commands that configure application(s) 116.

User interface 110 and input device 111 support interaction with computing device 100 through displays, touch panels, keyboards, pointing devices, or similar hardware. These components may be used to configure operational parameters, initiate learning routines, adjust excitation patterns, or monitor computed control outputs. Power source 112 provides electrical energy to computing device 100 and may include a rechargeable battery, an external power adapter, or other suitable power components.

Decentralizer 180 processes decentralized control architectures produced by decomposer 175. Prescaler 185 performs prescaling transformations that adjust conditioning characteristics of regressions associated with decentralized control loops. Parameter updater 187 modifies controller parameters during iterative learning cycles. Trajectory data collector 197 accumulates state and control data from the aerospace system or simulation environment. Probing input generator 198 produces probing inputs that increase persistence of excitation and forwards the probing inputs to multi-injection module 190. Multi-injection module 190 applies reference-command variations and probing inputs during operation of the aerospace system. Reinforcement learning module 195 trains control parameters using learning data provided by trajectory data collector 197 and other components of application(s) 116. Reinforcement learning module 195 produces control parameter updates and forwards the updated parameters to updated control parameter output 199 for external use in controlling aerospace platforms.

In some examples, reinforcement learning module 195 may be configured to generate a schedule of control parameters corresponding to different operating conditions of the aerospace vehicle. For example, reinforcement learning module 195 may execute the decentralized learning process described herein at a plurality of distinct trim conditions, such as variations in angle of attack (AOA), Mach number, altitude, or vehicle mass. The resulting sets of optimal control parameters K₁ and K₂ for each operating point may be stored within memory 104 as a gain schedule. During flight operations, parameter updater 187 may determine the current operating condition of the aerospace vehicle and interpolate between stored gain values to obtain a corresponding pair of controller parameters. In this way, the decentralized learning framework may be extended beyond a single equilibrium point, enabling adaptive control performance across broad regions of the flight envelope.

In practical implementations, computing device 100 interfaces directly with actuators and sensors of an aerospace vehicle through network interface 106 so that the learned control parameters produced by reinforcement learning module 195 are applied to physically control the vehicle. During operation, multi-injection module 190 issues the reference-command variations and probing inputs to the vehicle's guidance and actuation channels, causing measurable changes in throttle, control-surface deflection, or other effector positions. These signals generate corresponding physical state trajectories, which are recorded by trajectory data collector 197 using onboard inertial measurement units, air-data sensors, GPS, or other state-estimation subsystems. The resulting trajectory data reflect the real-time dynamic response of the vehicle to the injected commands and are transformed by prescaler 185 before being used to form the learning regression. Reinforcement learning module 195 then updates controller parameters that are subsequently sent through updated control parameter output 199 to the vehicle's control interfaces. In this way, the decentralized learning process is integrated into a complete closed-loop control cycle in which the updated control parameters computed by device 100 directly govern the physical behavior of the aerospace vehicle during flight.

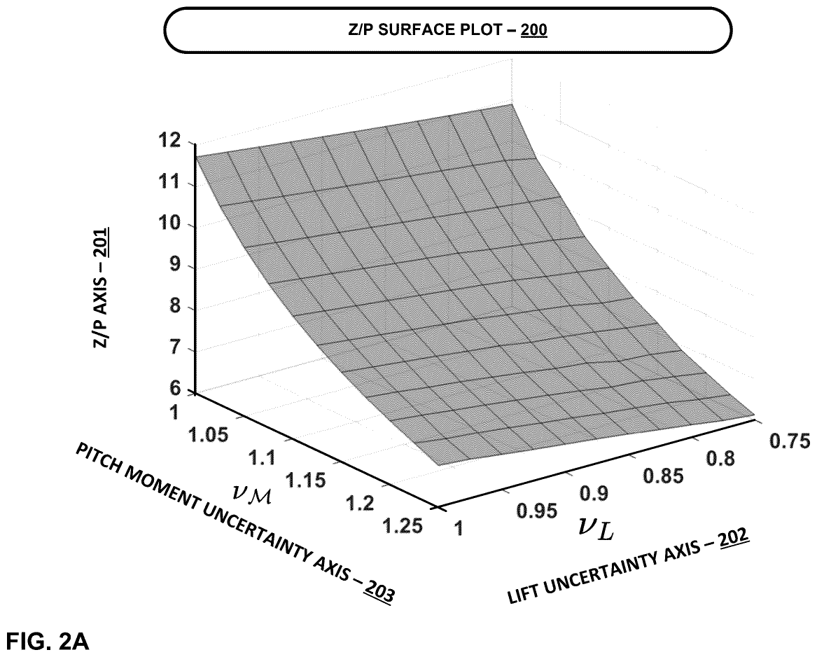

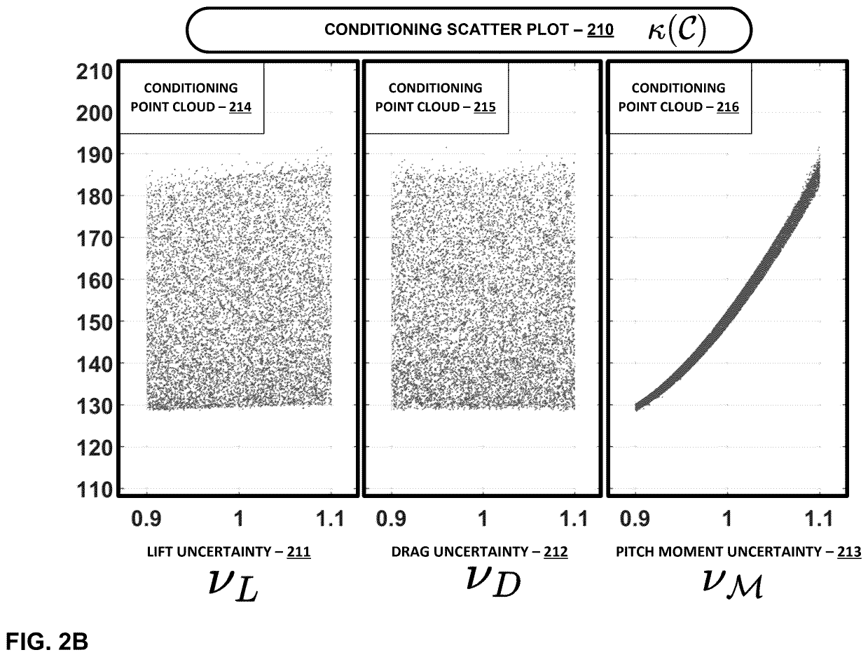

FIGS. 2A and 2B depict the Z/P ratio and controllability matrix conditioning of a hypersonic vehicle, in accordance with aspects of the disclosure. FIG. 2A presents z/p surface plot 200, which includes z/p axis 201, lift uncertainty axis 202, and pitch moment uncertainty axis 203. Z/p surface plot 200 illustrates the variation of the Z/P ratio across combinations of lift uncertainty ν^{L} and pitch moment uncertainty ν^{M} in the presence of modeling error. A surface mesh extends across lift uncertainty axis 202 and pitch moment uncertainty axis 203 and is supported visually by the grid frame, while the resulting Z/P values are shown along z/p axis 201.

FIG. 2B presents conditioning scatter plot 210, which includes lift uncertainty 211, drag uncertainty 212, pitch moment uncertainty 213, conditioning point cloud 214, conditioning point cloud 215, and conditioning point cloud 216. Conditioning scatter plot 210 depicts the distribution of κ(C) values obtained from 10,000 independent random trials of modeling error. Conditioning point cloud 214 corresponds to uncertainty variation along lift uncertainty 211, conditioning point cloud 215 corresponds to uncertainty variation along drag uncertainty 212, and conditioning point cloud 216 corresponds to uncertainty variation along pitch moment uncertainty 213, illustrating how changes in aerodynamic coefficient uncertainties influence controllability matrix conditioning across repeated trials.

### Introduction:

Flight control of hypersonic vehicles (HSVs) presents dynamic challenges due to a combination of open-loop instability and nonminimum-phase behavior. In spite of these challenges, classical approaches to flight control of HSVs have achieved significant success within frameworks such as decentralized Linear Quadratic (LQ) methods, sequential loop closure, generalized mixed-sensitivity H\hat{ }∞ techniques, adaptive control, feedback linearization, and other established strategies. These classical approaches require a known dynamic model of the HSV, yet constructing such a model is exceptionally difficult due to hypersonic aeropropulsive and aeroelastic effects that introduce strong nonlinearities, rapid dynamic coupling, and sensitivity to uncertain aerodynamic conditions.

Reinforcement learning (RL), which uses approximation and environment data to solve optimal control problems, emerged as a systematic method beginning in the early 1980s with potential applicability for mitigating model uncertainty. Continuous-time reinforcement learning (CT-RL), including adaptive dynamic programming (ADP) formulations, has produced substantial theoretical results but has faced challenges in practical implementation. A central issue is the lack of persistence of excitation (PE), which yields poor conditioning of the learning regression matrix and can cause learning failure. Analytical assumptions guaranteeing convergence are strong and often unrealizable in practice; moreover, CT-RL formulations typically assume PE is already satisfied, despite lacking constructive mechanisms for ensuring it. To address this issue, algorithm conditioning is used as a numerical proxy for persistence of excitation. This constructive diagnostic, adopted by HSV framework 170, provides an actionable metric for evaluating whether learning data are sufficiently informative. The κ(C) distributions shown within conditioning scatter plot 210 across conditioning point cloud 214, conditioning point cloud 215, and conditioning point cloud 216 illustrate these conditioning characteristics under varied model-error scenarios.

Deep CT-RL methods exist that demonstrate promising results for simple nonlinear systems such as the cart-pole and pendulum. However, these methods require extremely large data volumes, often on the order of 10\hat{ }6 trajectories, which is infeasible in hypersonic flight where available trajectory data are limited.

Rather than designing general reinforcement learning methods and then applying them to HSVs, multiple prior works attempt specialized RL-based HSV control structures. However, these approaches exhibit limitations for real-world flight control. Prior art frequently utilizes simplified aerodynamic models such as versions of the Wang-Stengel model that omit Mach-dependent aerodynamic coefficient variation, a substantial limitation in high-Mach hypersonic regimes. Neural control designs and adaptive critic designs share this limitation. Other adaptive dynamic programming approaches, including backstepping-neural frameworks and feedback-linearization-based reinforcement learning, require access to high-order partial derivatives of the vehicle dynamics, which is restrictive, sensitive to uncertainty, and difficult to implement reliably.

Furthermore, existing frameworks typically lack constructive stability guarantees beyond boundedness results for tracking or approximation error. Stability conditions require numerous pointwise inequalities to hold along closed-loop trajectories, with no established method to verify these conditions constructively. Resulting controller architectures are often highly complex, preventing comparison against classical control methods and limiting practical adoption.

Equally significant is that existing reinforcement-learning-based HSV works almost never present systematic evaluations of modeling-error effects on closed-loop stability or performance. Results are typically shown only for nominal models or for a single selection of uncertainty parameters, which is insufficient for mission-critical hypersonic flight. No prior frameworks present thorough ablation studies over initial conditions, nor do they evaluate numerical learning properties such as algorithm conditioning or κ(C) behavior, issues illustrated in conditioning scatter plot 210. Learning sensitivity to initial condition variation, excitation quality, and model uncertainty is significant, particularly because reinforcement learning (RL) performance depends strongly on data quality and persistence of excitation.

Accordingly, substantially elevated standards for numerical validation, uncertainty evaluation, and conditioning analysis are required to make reinforcement learning methods reliably applicable to flight control. New reinforcement learning evaluation frameworks tailored to aerospace dynamics are therefore needed.

### Method

HSV framework 170 utilizes a three-pronged, designer-centric approach aimed at improving algorithm learning quality. First, the natural translational/rotational dynamic decomposition in aircraft dynamics is leveraged to decentralize the control solution. This approach breaks the optimal control problem into lower-dimensional subproblems, reducing the numerical complexity of the algorithm. Second, the multi-injection (MI) method realigns the reinforcement learning (RL) excitation framework with classical input/output insights. Third, a modulation-enhanced excitation (MEE) framework is presented, which prescales the learning regression matrix through nonsingular transformations of the state variables. The resulting critic weights, and thus the critic approximation of the cost functional, improve both learning and control performance by HSV framework 170.

These algorithmic elements, when combined, enable HSV framework 170 to provide a decentralized excitable integral reinforcement learning (dEIRL) approach to an LQ-optimal full-state feedback control law for a structurally identical architecture developed specifically for hypersonic vehicles (HSVs) and extensively tested in previous studies. Consequently, decentralized excitable integral reinforcement learning (dEIRL) with data-driven learning and adaptation retains beneficial properties, such as linear quadratic (LQ) optimality, closed-loop stability, and frequency-domain stability robustness guarantees, along with its associated classical control design insights.

Moreover, aside from standard Lipschitz, stabilizability, and detectability assumptions, application of dEIRL by HSV framework 170 places no additional structural or algorithmic restrictions on the HSV model. This flexibility makes the dEIRL approach as implemented by HSV framework 170 potentially viable for realistic testing conditions, as system uncertainties are directly learned from data rather than relying on explicit estimates of system model uncertainty.

In such a way, the dEIRL method applied by HSV framework 170, utilizing the initial reinforcement learning (RL) design approach for hypersonic vehicle (HSV) applications, offers substantial demonstrated performance guarantees. HSV framework 170 implements the above mentioned three-pronged, designer-centric approach that incorporates decentralization, multi-injection (MI), and modulation-enhanced excitation to constructively improve learning performance while retaining target properties of decentralized excitable integral reinforcement learning (dEIRL), such as learning convergence, solution optimality, and closed-loop stability.

Further still, a first-of-its-kind RL performance evaluation framework for aerospace systems is provided, which combines a comprehensive suite of 35 quantitative metrics. These metrics evaluate learning, stability, frequency-domain characteristics, and closed-loop performance across a total of 12,872 independent learning trial ablations involving modeling error and initial conditions.

Ultimately, the dEIRL approach as implemented by HSV framework 170 is shown to outperform comparable designs in terms of solution optimality, algorithm conditioning, stability robustness, and closed-loop performance, particularly when model uncertainty is introduced.

HSV Model and Decentralized Control Structure: HSV Framework 170 may adopt the standard Wang and Stengel model, developed in previous works based on NASA Langley's winged-cone tabular aeropropulsive data. The standard model has served as a benchmark for HSV control development and has been utilized in seminal classical control techniques. Simplified variants of the standard model have also been employed in state-of-the-art RL-based control applications. The resulting model of HSV Framework 170 as described herein deviates in at least the following two ways: First, an elevator-lift increment coefficient C_{L,δ}_{_{E}} is added from the data to capture nonminimum phase behavior. Second, the angle of attack (AOA) dependence from the thrust coefficient C_{T} is removed, as AOA dependencies were considered negligible in the original propulsion model and were excluded in subsequent studies.

Consider the following HSV longitudinal model as set forth according to Equation 1, set forth below, as follows:

$$\dot{V} = \frac{T cos α - D}{m} - \frac{μsin γ}{{r}^{2}} ,$$

$$\dot{γ} = \frac{L + T sin α}{mV} - \frac{( μ - {V}^{2} r ) cos γ}{{Vr}^{2}} ,$$

$$\dot{θ} = q$$

$$\dot{q} = \frac{ℳ}{{I}_{yy}}$$

$$\dot{h} = V sin γ$$

where V is the vehicle airspeed, γ is the flight path angle (FPA), α is the angle of attack (AOA), and θ≙α+γ is the pitch attitude, q is the pitch rate, and h is the vehicle altitude. The variable r(h)=h+R_{E} represents the total distance from the Earth's center to the vehicle, with R_{E}=20,903,500 ft. as the radius of the Earth.

The gravitational parameter μ=Gm_{E}=1.39×10¹⁶ ft³/s², where G is Newton's gravitational constant and my is the mass of the Earth. Lift L, drag D, thrust T, and pitching moment M are defined according to Equation 2, set forth below, as follows:

$$L = \frac{1}{2} ρ {V}^{2} {SC}_{L} , D = \frac{1}{2} ρ {V}^{2} {SC}_{D} , T = \frac{1}{2} ρ {V}^{2} {SC}_{T} , ℳ = \frac{1}{2} ρ {V}^{2} S \overline{c} {C}_{ℳ}$$

where ρ is the local air density, S=3603 ft² is the wing planform area, and c̅=80 ft is the mean aerodynamic chord of the wing. The air density ρ and speed of sound a are modeled as functions of altitude h by the following equations: ρ=0.00238e^{-h/24,000}, a=8.99×10⁻⁹ h²−9.16×10⁻⁴ h+996, and the Mach number M≙(V/a).

The lift coefficient C_{L}, drag coefficient C_{D}, moment coefficient [symbol] , and thrust coefficient C_{T} are given by Equations 3 through 11:

Equation 3, is set forth below, as follows:

$${C}_{L} = {C}_{L , α} + {C}_{L , {δ}_{E}} ;$$

Equation 4, is set forth below, as follows:

$${C}_{L , α} = {v}_{L} α ( 0.493 + \frac{1.91}{M} ) ;$$

Equation 5, is set forth below, as follows:

$${C}_{L , {δ}_{E}} = ( - 0.2356 {α}^{2} - 0.004518 α - 0.02913 ) {δ}_{E} ;$$

Equation 6, is set forth below, define:

$${C}_{D} = {v}_{D} 0.0082 ( 171 {α}^{2} + 1.15 α + 1 ) ( 0.0012 {M}^{2} - 0.054 M + 1 ) ;$$

Equation 7, is set forth below, as follows:

$${C}_{ℳ} = {C}_{ℳ , α} + {C}_{ℳ , q} + {C}_{ℳ , {δ}_{E}} ;$$

Equation 8, is set forth below, as follows:

$${C}_{ℳ , α} = {v}_{ℳ} {10}^{- 4} ( 0.06 - {e}^{- \frac{M}{3}} ) ( - 6565 {α}^{2} + 6875 α + 1 ) ;$$

Equation 9, is set forth below, as follows:

$${C}_{ℳ , q} = ( \frac{q \overline{c}}{2 V} ) ( - 0.025 M + 1.37 ) ( - 6.83 {α}^{2} + 0.303 α - 0.23 ) ;$$

Equation 10, is set forth below, as follows:

$${C}_{ℳ , {δ}_{E}} = 0.0292 ( {δ}_{E} - α ) ;$$

and

Equation 11, is set forth below, as follows:

$${C}_{T} = \{ \begin{matrix}0.0105 ( 1 + \frac{17}{M} ) ( 1 + 0.15 ) {δ}_{T} , {δ}_{T} < 1 \\ 0.0105 ( 1 + \frac{17}{M} ) ( 1 + 0.15 {δ}_{T} ) , {δ}_{T} \geq 1\end{matrix} .$$

In Equations 3 through 11, δ_{E} is the elevator deflection, δ_{T} is the throttle setting, and ν_{L}, ν_{D}, [symbol] ∈ [symbol] are unknown modeling error parameters (nominally 1) in the basic lift increment coefficient C_{L,α} of Equation (4), drag coefficient C_{D} of Equation (6), and basic pitch moment coefficient [symbol] _{,α} of Equation (8), respectively.

The HSV model described in Equation (1) is of order n=5, with states x=[V, γ, θ, q, h]^{T}. The m=2 controls are u=[δ_{T}, δ_{E}]^{T}, and the outputs considered are y=[V, γ]^{T}. As in previous studies, a steady level flight condition is examined where qₑ=0, γₑ=0°, at Mₑ=15 and hₑ=110,000 ft, corresponding to an equilibrium airspeed Vₑ=15,060 ft/s. In this flight condition, the vehicle is trimmed at αₑ=1.7704° by the controls δ_{T,e}=0.1756 (Tₑ=4.4966×10⁴ lb) and δ_{E,e}=−0.3947°.

HSV Dynamic Challenges: The HSV model encompasses a range of dynamic challenges faced by real-world flight control designers. First, the HSV is open-loop unstable. Linearization of the model around the equilibrium flight condition (xₑ, uₑ) reveals open-loop eigenvalues at s=−0.8291, 0.7165 (short-period modes), s=−0.00001±0.0276j (phugoid modes), and s=0.0005 (altitude mode). The dominant unstable short-period right half-plane pole (RHPP) at s=0.7165 is associated with the vehicle's pitch-up instability (long vehicle forebody, aftward-set center of mass). As is typical with tail-controlled aircraft, the elevator-FPA map is nonminimum phase. The linearized plant has transmission zeros at s=8.3938, −8.4620, with the right half-plane zero (RHPZ) at s=8.3938 attributable to the elevator-FPA map (negative lift increment in response to pitch-up elevator deflections). An in-depth static and dynamic analysis of the studied HSV model, including trim throttle δ_{T,e}, trim elevator δ_{E,e}, RHPP location, RHPZ location, RHPZ/RHPP ratio, and controllability analysis, is provided below.

With reference again to FIGS. 2A and 2B, the RHPZ/RHPP ratio is plotted as a function of modeling error in lift/pitch moment ν_{L}/ [symbol] and the condition number of the HSV controllability matrix C∈ [symbol] {n×(mn)}, based on 10,000 random trials of model uncertainty tested in Section IX. Analogous plots for the model uncertainty parameters tested below. As seen, the Z/P ratio decreases significantly as modeling error increases and is particularly sensitive to variations in pitch moment coefficient [symbol] , decreasing from 11.72 nominally to 6.12 at a minimum, which results in a significantly more challenging control problem. Similarly, the system remains controllable, with the controllability conditioning κ( [symbol] ) remaining below 200, and controllability is most significantly degraded by the pitch moment coefficient [symbol] .

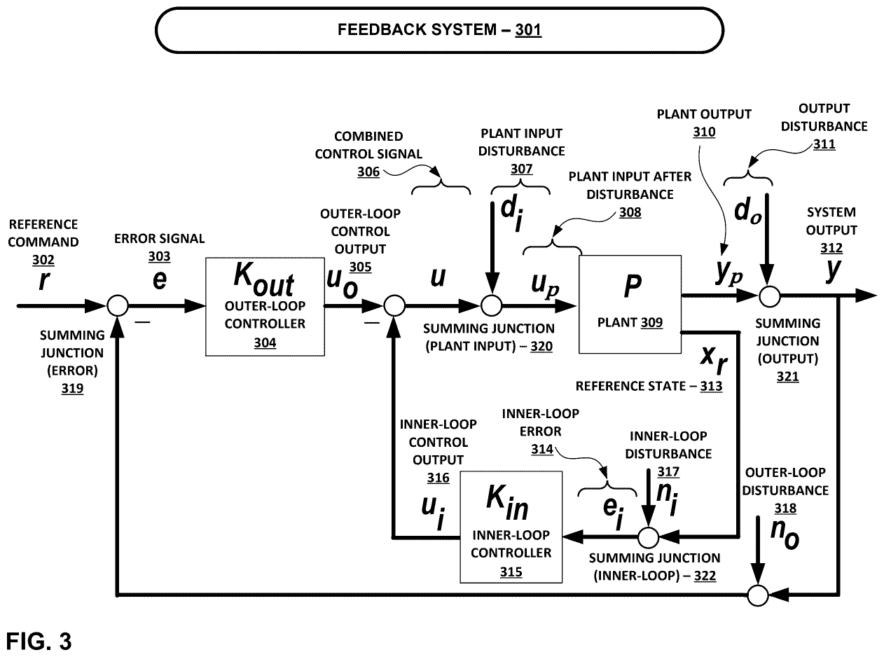

FIG. 3 depicts a hierarchical inner-outer loop feedback structure, in accordance with aspects of the disclosure. In particular, feedback system 301 of FIG. 3 illustrates a hierarchical inner-outer loop control structure that organizes reference tracking, disturbance rejection, and closed-loop stabilization across two coupled feedback loops. Reference command 302 provides the commanded signal r and forwards this signal to summing junction (error) 319. Summing junction (error) 319 subtracts system output 312 from reference command 302 to generate error signal 303. Error signal 303 flows into outer-loop controller 304, which applies the outer-loop control law Kₒᵤₜ to produce outer-loop control output 305, denoted uₒ. Inner-loop control output 316, denoted uᵢ, is combined with uₒ to form combined control signal 306, denoted u. Combined control signal 306 represents the total commanded input before disturbance injection and propagates toward summing junction (plant input) 320.

Summing junction (plant input) 320 receives combined control signal 306 and plant input disturbance 307, which is denoted dᵢ. Summing junction (plant input) 320 algebraically combines u and dᵢ to produce plant input after disturbance 308, denoted uₚ. The signal uₚ is directed to plant 309. Plant 309 represents the controlled hypersonic vehicle dynamics and outputs plant output 310, denoted yₚ. Output disturbance 311, denoted dₒ, is injected at summing junction (output) 321, where plant output 310 and output disturbance 311 are combined to form system output 312, denoted y.

System output 312 is returned to summing junction (error) 319, closing the outer feedback loop, and is also provided to summing junction (inner-loop) 322. Summing junction (inner-loop) 322 receives reference state 313, denoted xᵣ, and inner-loop disturbance 317, denoted nᵢ. Summing junction (inner-loop) 322 subtracts xᵣ and nᵢ from system output 312 to form inner-loop error 314, denoted eᵢ. Inner-loop error 314 is forwarded to inner-loop controller 315. Inner-loop controller 315 applies the inner-loop control law Kᵢₙ to eᵢ to generate inner-loop control output 316, denoted uᵢ. Inner-loop control output 316 feeds forward to summing junction (plant input) 320 and acts in parallel with outer-loop control output 305 to shape the total applied control signal u. The interaction between Kᵢₙ and Kₒᵤₜ shown in FIG. 3 captures the decentralized hierarchical structure used to stabilize pitch dynamics and regulate flightpath or velocity dynamics in a manner consistent with sequential loop closure principles.

Outer-loop disturbance 318, denoted nₒ, enters the feedback structure at summing junction (error) 319. The disturbance nₒ alters error signal 303, influencing the signal processed by outer-loop controller 304 and propagating through the remainder of the closed-loop architecture. The combined effect of disturbances dᵢ, dₒ, nᵢ, and nₒ models injection of reference disturbances, measurement disturbances, and plant-level disturbances used for analysis of sensitivity, complementary sensitivity, and disturbance rejection properties.

The arrangement of reference command 302, error signal 303, outer-loop controller 304, combined control signal 306, summing junction (plant input) 320, plant 309, summing junction (output) 321, system output 312, reference state 313, summing junction (inner-loop) 322, inner-loop error 314, inner-loop controller 315, inner-loop control output 316, and disturbances 307, 311, and 317 yields a decentralized hierarchical feedback architecture consistent with the mathematical structure developed below and suitable for describing inner-outer loop optimal control relationships, closed-loop map definitions, and decentralized learning formulations.

Decentralized Hierarchical Inner-Outer Loop Control Structure: A decentralized design methodology, structurally identical to HSV framework 170 was extensively tested on HSVs. As a result, the RL-based framework inherits significant advantages from classically based performance guarantees. Controllers are designed separately for the velocity subsystem (associated with the airspeed V and throttle control δ_{T}) and the rotational subsystem (associated with the FPA γ, attitude θ, pitch rate q, and elevator control δ_{E}). As in prior works, altitude h is not fed back into the control design for controllability reasons, although it remains included in the nonlinear simulation. To achieve zero steady-state error for step reference commands, the plant 309 is augmented at the output with an integrator bank z=∫ydτ=[z_{V}, z_{γ}]^{T}=[∫Vdτ, ∫γdτ]^{T}. For dEIRL, the state/control vectors are partitioned as x₁=[Z_{V}, V]^{T}, u₁=δ_{T}(n₁=2, m₁=1), and x₂=[z_{γ}, γ, θ, q]^{T}, u₂=δ_{E}(n₂=4, m₂=1). Applying the LQ servo design framework to each of the loops yields an LQ-optimal decentralized controller

$$K = diag ( {K}_{1}^{*} , {K}_{2}^{*} ) .$$

The decentralized hierarchical feedback structure is depicted in FIG. 3, where xᵣ=[θ, q]^{T} comprises the inner-loop feedback states, and the inner-loop controller Kᵢₙ and outer-loop controller Kₒᵤₜ are given by Equation 12, set forth below, as follows:

$${K}_{in} ( s ) = [ \begin{matrix}0 & 0 \\ {g}_{i} {z}_{i} & {g}_{i}\end{matrix} ]$$

$${K}_{out} ( s ) = [ \begin{matrix}{K}_{V} ( s ) & 0 \\ 0 & {K}_{γ} ( s )\end{matrix} ] = [ \begin{matrix}\frac{{g}_{1} ( s + {z}_{1} )}{s} & 0 \\ 0 & \frac{{g}_{2} ( s + {z}_{2} )}{s}\end{matrix} ] .$$

The resulting hierarchical control framework consists of two primary loops.

The first loop j=1, referred to as the velocity loop, employs a single-loop Proportional-Integral (PI) controller K_{V} of Equation (12) for the velocity subsystem. This loop operates with lower bandwidth due to the inherently low-bandwidth nature of the velocity dynamics.

The second loop j=2, the flightpath loop, utilizes a hierarchical control structure with a Proportional-Derivative (PD) controller Kᵢₙ of Equation (12) for the inner loop (attitude) and a PI controller for the outer loop (FPA control). The inner-loop PD controller Kᵢₙ of Equation (12) manages the pitch subsystem xᵣ=[θ, q]^{T}, defined by the states θ and q. The feedback of pitch θ has demonstrated reliable stability properties and closed-loop performance in previous applications. This controller takes advantage of the high bandwidth of the elevator-pitch map and the minimum-phase dynamics, enabling sufficient closed-loop bandwidth to stabilize the natural pitch-up instability. The high bandwidth of the inner pitch loop supports the design of the outer-loop PI controller K_{γ} of Equation (12) for the flightpath angle. After stabilizing the inner pitch loop, the outer FPA loop operates with sufficiently low bandwidth to prevent excitation of the nonminimum phase elevator-FPA dynamics.

Utilizing HSV framework 170, reference command prefilters are introduced to shape the input commands before they reach the feedback loops. The velocity reference prefilter W₁ is defined as

$${W}_{1} = \frac{{z}_{1}}{s + {z}_{1}}$$

and the FPA reference prefilter W₂ is defined as

$${W}_{2} = \frac{{z}_{2}}{s + {z}_{2}} .$$

These filters ensure that the reference commands delivered to the outer-loop controller 304 and inner-loop controller 315 are bandwidth-matched to the dynamics of the velocity and flight-path subsystems, enabling smooth transient behavior while preventing undesirable excitation of high-frequency modes.

After applying basic block diagram algebra, the dEIRL control structure K can be expressed as

$$K = diag ( {K}_{1}^{*} , {K}_{2}^{*} )$$

of Equation (12), with the identifications

$${K}_{1}^{*} = [ {g}_{1} {z}_{1} , {g}_{1} ] , and$$

$${K}_{2}^{*} = [ {g}_{2} , {z}_{2} , {g}_{2} , {g}_{i} {z}_{i} , {g}_{i} ]$$

corresponding to the optimal LQ controller parameters. These optimal parameters are learned online by the dEIRL method.

With reference again to FIG. 3, the feedback system 301 includes several closed-loop maps, including the sensitivity at the error signal, defined as Sₑ≙T_{r→e}, and the complementary sensitivity, Tₑ≙T_{r→y}. The sensitivity at the control signal (plant 309 input) is defined as Sᵤ≙T_{d}_{ᵢ}_{→u}_{ₚ}, and the complementary sensitivity is Tᵤ≙T_{d}_{ᵢ}_{→y}.

Decentralized Excitable Integral Reinforcement Learning: The problem is formulated within the context of a decentralized affine nonlinear system, denoted by (f, g), which provides a physically motivated partition according to Equation 13, set forth below, as follows:

$$[ \begin{matrix}{\dot{x}}_{1} \\ {\dot{x}}_{2}\end{matrix} ] = [ \begin{matrix}{f}_{1} ( x ) \\ {f2}_{1} ( x )\end{matrix} ] + [ \begin{matrix}{g}_{11} ( x ) & {g}_{12} ( x ) \\ {g}_{21} ( x ) & {g}_{22} ( x )\end{matrix} ] [ \begin{matrix}{u}_{1} \\ {u}_{2}\end{matrix} ] .$$

No assumptions are made regarding dynamic coupling between the loops j=1, 2; the loops may be fully coupled. Here, x∈ [symbol] represents the state vector, u∈ [symbol] , the control vector xⱼ∈ [symbol] , uⱼ∈ [symbol] ⱼ (j=1, 2), where the functions n₁+n₂=n and m₁+m₂=m, and f: [symbol] → [symbol] , g: [symbol] → [symbol] are known. It is assumed that f and g are Lipschitz on a compact set containing the origin in its interior, and that f(0)=0. The functions are defined as gᵢ: [symbol] → [symbol] , gⱼ(x)=[gⱼ₁(x) gⱼ₂(x)] for convenience.

The quadratic cost function is considered according to Equation 14, set forth below, as follows:

$$J ( {x}_{0} ) = {\int }_{0}^{∞} ( {x}^{T} Qx + {u}^{T} Ru ) d τ ;$$

with the penalty matrices Q∈ [symbol] , Q=Q^{T}≥0 and R∈ [symbol] , R=R^{T}>0 are the state and control penalty matrices, respectively. The block-diagonal cost structure is Q=diag(Q₁, Q₂), R=diag(R₁, R₂), where Qⱼ∈ [symbol] , Qⱼ=Qⱼ^{T}≥0, and Rⱼ∈ [symbol] ,

$${R}_{j} = {R}_{j}^{T} > 0 ( j = 1 , 2 ) .$$

In addition to cost, the design specifications are considered and are outlined below, as follows:

Closed-Loop Design Specifications: A design is termed “acceptable” when it meets the following five criteria:
1) 0% steady-state error to step reference commands r,
2) 0% steady-state error to step input disturbances dᵢ,
3) Velocity: 1% settling time t_{s,V,1%}≤75 s, overshoot M_{p,V}≤5% throttle δ_{T}≤0.4 for r_{V}≤100 ft/s,
4) FPA: 1% settling time t_{s,γ,1%}≤10 s, overshoot M_{p,γ}≤5%, elevator |δ_{E}|≤5° for r_{γ}≤1 deg, and
5) Peak closed-loop maps: ∥Sₑ [symbol] , ∥Tₑ [symbol] , ∥Sᵤ [symbol] , ∥ Tᵤ [symbol] ≤6 dB.

The dEIRL Algorithm: Leveraging Kleinman's structure, dEIRL algorithm uses state-action trajectory data (x, u) to iteratively solve for the optimal policy of the nonlinear system of Equation (13).

Kleinman's Algorithm for Linear Systems: The Kleinman algorithm addresses linear time-invariant systems defined by \dot{x}=Ax+Bu, where A∈ [symbol] and B∈ [symbol] . The assumptions here are that the pair (A, B) is stabilizable and that (Q^{1/2}, A) is detectable. The Kleinman algorithm iteratively solves for the optimal Linear Quadratic Regulator (LQR) control K*=R⁻¹ B^{T} P*, where P*∈ [symbol] , P*=P*^{T}>0 is the solution to the Riccati equation. The Kleinman algorithm may also be extended to decentralized linear systems, where A={Aⱼₖ}_{1≤j,k≤2}, B={Bⱼₖ}_{1≤j,k≤2} are partitioned according to (f, g) of Equation (13). For 1≤j≤2, suppose that K_{0,j}∈ [symbol] is chosen such that Aⱼⱼ−BⱼⱼK_{0,j} is Hurwitz. At each iteration i=0, 1, . . . , let P_{i,j}∈ [symbol] , P_{i,j}=P_{i,j}^{T}>0 be the symmetric positive-definite solution of the algebraic Lyapunov equation (ALE), according to Equation 15, set forth below, as follows:

$${( {A}_{jj} - {B}_{jj} {K}_{i , j} )}^{T} {P}_{i , j} ( {A}_{jj} - {B}_{jj} {K}_{i , j} ) + {K}_{i , j}^{T} {R}_{j} {K}_{i , j} + {Q}_{j} = 0.$$

After solving the ALE P_{i,j} of Equation (15), the controller K_{i+1,j}∈ [symbol] is recursively updated as

$${K}_{i + 1 , j} = {R}_{j}^{- 1} {B}_{jj}^{T} {P}_{i , j} .$$

Critic Network Structure: The critic neural network (NN) structure is defined by V(x)=V₁(x₁)+V₂(x₂), where Vⱼ(xⱼ)=(xⱼ⊗xⱼ)^{T} svec(P_{i,j}), and where ⊗, denotes the symmetric Kronecker product, and where svec represents the vectorization operator. In this setup, svec(P_{i,j})∈ [symbol] , nⱼ [symbol] (nⱼ(nⱼ+1)/2), is the critic weight vector derived through dEIRL learning, as referenced in Equation (18). By applying standard identities for symmetric Kronecker products, this yields

$${V}_{j} ( x ) = {( {x}_{j} \underline{⊗} {x}_{j} )}^{T} svec ( {P}_{i , j} ) = {x}_{j}^{T} {P}_{i , j} {x}_{j} ,$$

aligning with the quadratic approximation form of the Kleinman algorithm.

Expression of dEIRL: Consider any feedback loop 1≤j≤2. Assume that K_{0,j}∈ [symbol] is selected such that Aⱼⱼ−BⱼⱼK_{0,j} is Hurwitz in loop j. First, rearrange the terms in Equation (13) according to Equation 16, set forth below, as follows:

$$\begin{matrix}{\dot{x}}_{j} = {w}_{j} ( x ) + {g}_{j} ( x ) u + {A}_{i , j} {x}_{j} + {B}_{j j} {K}_{i , j} {x}_{j} , \\ {w}_{j} ( x ) {=}^{Δ} {f}_{j} ( x ) - {A}_{j j} {x}_{j} , {A}_{i , j} {=}^{Δ} {A}_{j j} - {B}_{j j} {K}_{i , j}\end{matrix} .$$

The drift term wⱼ(x) [symbol] fⱼ(x)−Aⱼⱼxⱼ∈ [symbol] encompasses the following: (1) system nonlinearities, (2) dynamic coupling, and (3) potential model uncertainties, while Aⱼⱼ, Bⱼⱼ are the known nominal linearization terms of fⱼ, gⱼⱼ in Equation (13). Importantly, Equation (16) remains exact to the original nonlinear dynamics in Equation (13). Next, let t₀<t₁ be given. Differentiating the value function V along system trajectories yields

$${V}_{j} ( {x}_{j} ( {t}_{1} ) ) - {V}_{j} ( {x}_{j} ( {t}_{0} ) ) = {\int }_{{t}_{0}}^{{t}_{1}} ( d / d τ ) \{ {V}_{j} ( {x}_{j} ) \} d τ .$$

Along the solutions of the nonlinear system in Equation (13), applying Equation (16) results in Equation 17, set forth below, as follows:

$$[ - 2 {\int }_{{t}_{0}}^{{t}_{1}} ( {w}_{j} ( x ) + {g}_{j} ( x ) {u}_{j} + {B}_{j j} {K}_{i , j} {x}_{j} ) \underline{⊗} {x}_{j} d τ {+ ( {x}_{j} ( {t}_{1} ) + {x}_{j} ( {t}_{0} ) ) \underline{⊗} ( {x}_{j} ( {t}_{1} ) - {x}_{j} ( {t}_{0} ) ) ]}^{T} svec ( {P}_{i , j} ) = {[ {\int }_{{t}_{0}}^{{t}_{1}} {x}_{j} \underline{⊗} {x}_{j} d τ ]}^{T} s v e c ( {A}_{i , j}^{T} {P}_{i , j} + {P}_{i , j} {A}_{i , j} ) = - {[ {\int }_{{t}_{0}}^{{t}_{1}} {x}_{j} \underline{⊗} {x}_{j} dτ ]}^{T} s v e c ( {Q}_{j} + {K}_{i , j}^{T} {R}_{j} {K}_{i , j} ) ,$$

where the second equality in Equation (17) follows from the fact that

$${P}_{i , j} = {P}_{i , j}^{T} > 0$$

satisfies the ALE of Equation (15). The integral reinforcement Equation (17) is now of the required form for learning regression: The terms in brackets

$${[ - 2 {\int }_{{t}_{0}}^{{t}_{1}} ... ]}^{T}$$

svec(P_{i,j}) contain the system trajectory integral and difference data and will form a single row of the learning matrix A_{i,j} of Equation (19), multiplied on the right by the critic weight vector svec(P_{i,j})∈ [symbol] . Meanwhile, the term in svec

$$( {Q}_{j} + {K}_{i , j}^{T} {R}_{j} {K}_{i , j} )$$

requires only integral state data xⱼ and will form a single element of the learning vector b_{i,j} of Equation (19). Given lⱼ∈ [symbol] and a strictly increasing sequence

$${\{ {t}_{k , j} \}}_{k = 0}^{{l}_{j}} ,$$

applying Equation (17) at the sample instants leads to the least-squares regression according to Equation 18, set forth below, as follows:

$${A}_{i , j} s v e c ( {P}_{i , j} ) = {b}_{i , j} ,$$

where A_{i,j}∈ [symbol] , b_{i,j}∈ [symbol] are given according to Equation 19, set forth below, as follows:

$$\begin{matrix}{A}_{i , j} = - 2 [ {I}_{{x}_{j} , {w}_{j} + {g}_{j} u} + {{I}_{{x}_{j} , {x}_{j}} ( {I}_{{n}_{j}} \underline{⊗} {B}_{j j} {K}_{i , j} )}^{T} ] + {δ}_{{x}_{j} , {x}_{j}} , \\ {b}_{i , j} = - {I}_{{x}_{j} , {x}_{j}} svec ( {Q}_{j} + {K}_{i , j}^{T} {R}_{j} {K}_{i , j} )\end{matrix} .$$

In Equation 19, for two maps x, y: [t₀, t₁]→ [symbol] , the following definitions are given:

$${I}_{x , y} = {[ \begin{matrix}{\int }_{{t}_{0}}^{{t}_{1}} x ⊗ y d τ & … & {\int }_{{t}_{l - 1}}^{{t}_{l}} x ⊗ y d τ\end{matrix} ]}^{T} ∈ ; and$$

$${δ}_{x , y} = {[ ( x ( {t}_{1} ) + y ( {t}_{0} ) ) \underline{⊗} ( x ( {t}_{1} ) - y ( {t}_{0} ) ) … ( x ( {t}_{l} ) + y ( {t}_{l - 1} ) ) \underline{⊗} ( x ( {t}_{l} ) - y ( {t}_{l - 1} ) ) ]}^{T} ∈ {ℝ}^{l \times {\underline{n}}_{j}} .$$

Having performed the regression svec(P_{i,j}) of Equation (18), the controller is updated analogously to Kleinman's:

$${K}_{i + 1 , j} = {R}_{j}^{- 1} {B}_{j j}^{T} {P}_{i , j} ,$$

and so on.

Multi-Injection and Modulation-Enhanced Excitation for Improved Persistence of Excitation (PE): The physics-based principles underlying Multi-Injection (MI) and Modulation-Enhanced Excitation (MEE) are described in relation to HSV framework 170 and used to improve system PE and enhance numerical stability within the learning control solution. These techniques enable better conditioning for the dEIRL learning regression developed in Equation (18).

Multi-Injection: To achieve PE in ADP-based continuous-time reinforcement learning (CT-RL) designs, algorithms typically permit the designer to apply a control input of the form u=μ(x)+d, where μ represents a stabilizing policy and d denotes a probing noise, which is introduced at the plant 309 input. This corresponds to the location of the input disturbance dᵢ as illustrated in FIG. 3. However, the plant-input disturbance rejection properties traditionally sought from a classical control perspective, characterized by low input-disturbance sensitivity T_{d}_{ᵢ}_{→y}, tend to make the same controller less effective for persistence of excitation (PE), creating a conflict between classical control and reinforcement learning (RL) principles. To enhance excitation, the designer is enabled by HSV framework 170 to introduce the conventional continuous-time reinforcement-learning (CT-RL) probing noise d alongside a reference command excitation r (refer to FIG. 3). Injecting a reference command enables modulation of system excitation via the complementary sensitivity T_{r→y}, which is substantially more advantageous than the input-disturbance sensitivity T_{d}_{ᵢ}_{→y} from an input-output standpoint. Empirical evidence shows that MI achieves a reduction in the condition number of the dEIRL learning matrix A_{i,j} of Equation (19) by two to four orders of magnitude on the HSV model in preliminary tests.

Modulation-Enhanced Excitation: Modulation-Enhanced Excitation (MEE) evaluates the impact of nonsingular state transformations on the conditioning of the dEIRL learning matrix A_{i,j} of Equation (19). This process involves transformations of the form \tilde{x}=Sx, where S=diag(S₁, S₂), and where Sⱼ∈ [symbol] , with Sⱼ∈ [symbol] being invertible for (j=1, 2). These isomorphisms induce a transformed dynamic system (\tilde{f}, \tilde{g}) from the original functions (f, g) in Equation (13), resulting in a modified optimal control problem and dEIRL regression matrices Ã_{i,j}, \tilde{b}_{i,j} of Equation 18) within the \tilde{x}-coordinates. The core algebraic insight, as established in Theorem 5.2, is that the MEE-transformed dEIRL regression matrices Ã_{i,j}, \tilde{b}_{i,j} relate to the original matrices A_{i,j}, b_{i,j} of Equation (18) by Ã_{i,j}=A_{i,j}(Sⱼ⊗Sⱼ)^{T}, and \tilde{b}_{i,j}=b_{i,j}. This transformation is highly advantageous as it allows the designer to modulate the original dEIRL regression matrix A_{i,j} through arbitrary nonsingular transformations Sⱼ, to identify the optimal regression matrix Ã_{i,j} by exploring various transformation options Sⱼ.

In particular examples, prescaler 185 selects transformation matrices S₁ and S₂ based on first principles scaling logic. For example, prescaler 185 may define Sⱼ as a diagonal matrix with diagonal elements that normalize the associated state variables to a comparable numerical range, such as between negative one and one. By scaling the magnitudes of the state variables x₁ and x₂ before they enter the learning regression, prescaler 185 may prevent state components with naturally larger numerical values from dominating components with smaller numerical values, reducing the condition number of the learning matrix Aᵢⱼ and improving the numerical stability of the solution generated by reinforcement learning module 195.

Additional examples of first principles scaling logic used by prescaler 185 include selecting Sⱼ based on structural properties of the underlying aerospace dynamics model. For instance, prescaler 185 may define Sⱼ as a block diagonal matrix whose blocks correspond to translational and rotational state subsets, with each block scaled according to characteristic time constants or natural frequencies derived from nominal vehicle parameters. In further examples, prescaler 185 may set diagonal entries of Sⱼ proportional to reciprocals of partial derivatives ∂fᵢ/∂xₖ of a nominal drift model f(x), such that each state variable is scaled according to its local sensitivity within the system dynamics. In still other examples, prescaler 185 may select Sⱼ to equalize the magnitudes of state derivatives across the decentralized loops by scaling each state component according to an estimate of its dominant dynamic mode or its corresponding row norm in a linearized system matrix. These approaches provide explicit examples of transformation structures that improve conditioning by aligning the prescaled state variables with known physical scalings, such as aerodynamic force coefficients, pitch moment derivatives, or inertial coupling effects, reducing the condition number of the learning regression without relying on random exploration.

Empirical findings indicate that first-principles selections for the transformations Sⱼ yield a 25-fold improvement in the condition number of the MEE dEIRL learning matrix Ã_{i,j} of Equation (19) on the HSV model in preliminary tests.

Theoretical Results: The key guarantees of convergence, optimality, and closed-loop stability for dEIRL are demonstrated. The analysis assumes that the baseline dynamic conditions set forth in above are maintained.

Theorem III.1—Convergence, Optimality, and Closed-Loop Stability of dEIRL: For each 1≤j≤N that lⱼ∈ [symbol] and that the sampling instances

$${\{ {t}_{k , j} \}}_{k = 0}^{{l}_{j}}$$

are selected such that lₓ_{ⱼ}_{,x}_{ⱼ} of Equation (19) maintains full column rank nⱼ. If K_{0,j} is stabilizing in loop j, then the dEIRL algorithm and Kleinman's algorithm are equivalent in that the sequences

$${\{ {P}_{i , j} \}}_{i = 0}^{∞} and {\{ {K}_{i , j} \}}_{i = 1}^{∞}$$

produced by both are identical. Thus, the following hold:
1) Aⱼⱼ−BⱼⱼK_{i,j} is Hurwitz for all i≥0, and

$$2 ) {P}_{j}^{*} \leq {P}_{i + 1 , j} \leq {P}_{i , j} for all i \geq 0 , and {lim}_{i \to ∞} {K}_{i , j} = {K}_{j}^{*} , {lim}_{i \to ∞} {P}_{i , j} = {P}_{j}^{*} .$$

### Evaluation Studies:

Hyperparameter Selection and Setup: The evaluations were conducted using MATLAB R2022b on an NVIDIA RTX 2060 and an Intel i7 (9th Gen) processor. Numerical integrations were carried out using MATLAB's adaptive ode45 solver to maintain solution accuracy.

Hyperparameter Selection for dEIRL—Cost Structure: Penalty matrices were selected as follows: Q₁=diag(1.5, 5), R₁=7.5 in the velocity loop j=1 and Q₂=diag(100, 150, 0.5, 0), R₂=1 in the FPA loop j=2. These penalties were chosen to enable the resulting optimal LQR controllers to achieve the closed-loop design specifications outlined above on the nominal nonlinear HSV model.

Excitation Signals: Exploration noise d and reference command r were chosen based on preliminary assessments of this HSV model, generally targeting dominant frequency content near the peak of the respective closed-loop map (i.e., the P-sensitivity T_{d}_{ᵢ}_{→y} and complementary sensitivity T_{r→y}, respectively) to maximize excitation efficiency. The exploration noise d was set as d₁(t)=0.01 cos((2π/250)t) and d₂(t)=sin((2π/6)t)+1.5 cos((2π/25)t)+cos((2π/100)t). The reference command r was set as r₁(t)=5 cos((2π/10)t)+5 sin((2π/25)t)+50 sin((2π/100))t) and r₂(t)=0.03 sin((2π/6)t)+0.015×sin((2π/15)t). These combined excitations led to oscillations below 65 ft/s in the velocity channel and 0.2 degrees in the FPA channel. Throttle changes remained under 20%, while the elevator deflection remained below 1.5 degrees, which is suitable for real-world flight implementation.

Hyperparameters in dEIRL: Hyperparameters were systematically selected based on natural dynamic behavior, including sample period Tₛ=tₖ−tₖ₋₁, sample count l, iteration count i*, and initial stabilizing controller K₀. The sample period was chosen as T_{s,1}=6 s in the velocity loop j=1 and T_{s,2}=2 s in the FPA loop j=2 to capture high-bandwidth trajectory features. Sample counts were set to l₁=15, and l₂=25, with a higher count in the FPA loop due to its higher dimensionality l₂=25. Ten iterations

$${i}_{1}^{*} = {i}_{2}^{*} = 10$$

were observed to be sufficient for learning convergence. Initial stabilizing controllers K_{0,1}, K_{0,2} were selected. While these controllers may be chosen arbitrarily as long as they are stabilizing, nominal classical LQR designs were used for comparison. The penalties were set to Q₁_{₀}=l₂, R₁_{₀}=12.5, Q₂_{₀}=diag(1, 1, 0, 0), R₂_{₀}=0.025 to ensure that the nominal LQR design K₀=diag (K_{0,1}, K_{0,2}) met the required closed-loop design specification. While these choices provide a more challenging convergence problem, a simpler initialization could involve selecting Q₁_{₀}=Q₁, R₁_{₀}=R₁, and Q₂_{₀}=Q₂, R₂_{₀}=R₂, as used in the algorithm development, which would yield a closer approximation to the optimal controller. In such a way, dEIRL exhibits controller optimality reductions

$$‖ {K}_{0 , j} - {K}_{j}^{*} ‖ \to ‖ {K}_{{i}^{*} , j} - {K}_{j}^{*} ‖$$

on the order of 90% as modeling error is introduced. The algorithm was presented with a challenging learning problem from the perspective of convergence by initializing the parameters to a controller in specification but further in norm from the optimal.

Modeling Errors (ν) Tested: The effects of perturbing a single modeling error parameter in lift ν_{L} of Equation (4), drag ν_{D} of Equation (6), and pitch moment [symbol] of Equation (8) were analyzed using the dEIRL algorithm conditioning and policy optimality error. These modeling errors were tested over grids of values, with up to 25% modeling error and increments of 2.5%, according to Equation 20, set forth below, as follows:

$$\begin{matrix}{G}_{{v}_{L}} = [ 1 : - 0.025 : 0.75 ] , {G}_{{v}_{D}} = [ 1 : 0.025 : 1.25 ] \\ {G}_{{v}_{M}} = [ 1 : 0.025 : 1.25 ]\end{matrix} .$$

For instance, 0-25% modeling error with a step size of 2.5%. The direction of the respective perturbation (ν>1 or ν<1) was chosen to decrease the HSV's right half-plane zero (RHPZ)/right half-plane pole (RHPP) ratio, presenting the algorithm with the greatest possible learning challenge. The modeling error ablation described below studies modeling error in two parameters simultaneously, over sweep grids in lift/drag of G_{ν}_{_{L}}×G_{ν}_{_{D}}, lift/pitch moment G_{ν}_{_{L}}× [symbol] , and drag/pitch moment G_{ν}_{_{D}}× [symbol] . Finally, the random modeling error ablation studied 10,000 trials of modeling error, wherein all three parameters are simultaneously perturbed, each in a uniform distribution [symbol] (0.9, 1.1) (10% bidirectional disturbance). This uniform distribution was selected to keep results comparable to the leading CT-RL numerical studies in deep RL, which favor uniform distributions in modeling error in order to increase weight on the edge cases of the distribution.

In additional examples, reinforcement learning module 195 may adapt control parameters with respect to variations in lift uncertainty νL, drag uncertainty νD, and pitch moment uncertainty νM by learning updated drift contributions that implicitly encode the effects of these aerodynamic coefficient perturbations. Although νL, νD, and νM enter the hypersonic-vehicle dynamics as unknown modeling error parameters associated with the lift, drag, and pitch-moment equations, the learning data collected by trajectory data collector 197 reflect the combined influence of these uncertainties on the state-derivative evolution. Reinforcement learning module 195 may therefore update the controller parameters so that the resulting policy compensates for the uncertainty-induced changes in the system response. In this way, adaptation with respect to νL, νD, and νM is achieved through the learning of state-dependent drift terms that capture the aggregate impact of the underlying aerodynamic uncertainties, enabling the updated control parameters to reflect the effects of each uncertainty component without requiring explicit identification of νL, νD, or νM individually.

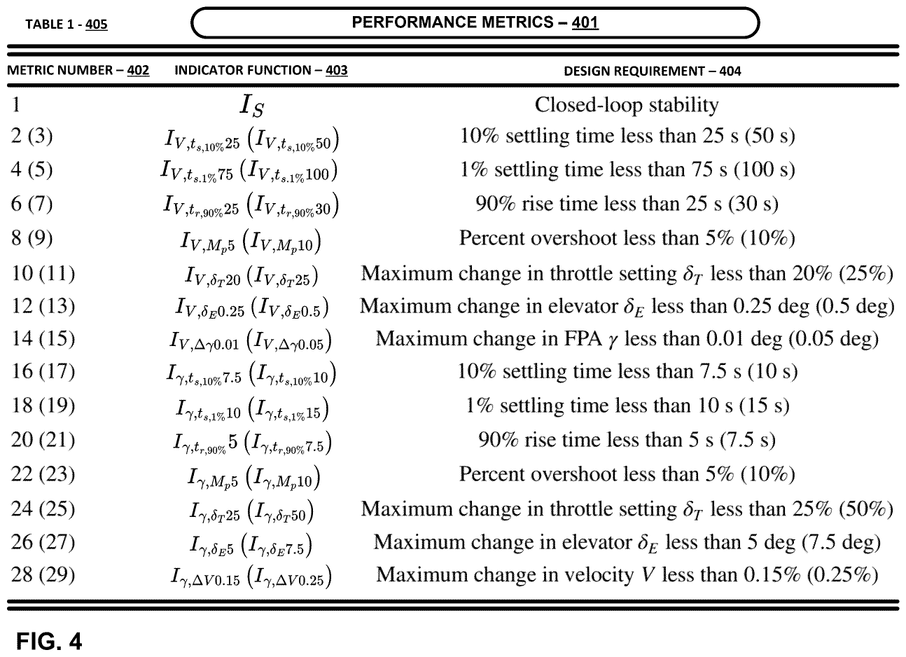

FIG. 4 depicts Table 1, set forth at element 405, summarizing closed-loop performance metrics, in accordance with aspects of the disclosure. In particular, FIG. 4 depicts performance metrics 401, metric number 402, indicator function 403, and design requirement 404. Table 1 405 summarizes closed-loop performance metrics used to evaluate stability, settling behavior, overshoot limits, and actuator-effort constraints for the decentralized hierarchical feedback architecture described above.

System initial conditions x₀ tested: Ablations were performed over initial conditions x₀ using the grid of values defined by Equation 21, set forth below, as follows:

$${G}_{{x}_{0}} = [ - 1 \; 00 : 25 : 100 ] ft / s \times [ - 1 : 0.25 : 1 ] de g .$$

Initialization of state variables: All remaining state variables were initialized to the trim condition xₑ. These grid bounds were selected because the closed-loop performance metrics presented in table 1 405 evaluate specifications for velocity reference commands of 100 ft/s and FPA reference commands of 1 degree. For analyses that focus on modeling-error effects, initial conditions were set to x₀=xₑ.

Algorithm conditioning: A detailed analysis of conditioning in the dEIRL algorithm is provided. Conditioning has been identified as a substantial numerical design limitation in existing continuous-time reinforcement learning (CT-RL) algorithms. For each learning trial, associated with fixed modeling-error parameters ν and initial conditions x₀, the maximum conditioning across learning iterations is defined by

$${max}_{0 \leq i \leq {i}^{*} - 1} κ ( {A}_{i , j} ) ( j = 1 , 2 ) ,$$

for j=1, 2, where A_{i,j} denotes the dEIRL learning regression matrix of Equation 18. This measure represents the worst-case conditioning over all iterations of a given trial.

Benchmarks tested and feedback linearization: To compare performance of dEIRL with established classical flight-control methods, a robust feedback-linearization (FBL) control architecture was evaluated for the model of HSV framework 170. For this benchmark, linear-quadratic (LQ) design parameters were selected as:

$${Q}_{1} = diag ( 8.54 \times 1 {0}^{- 6} , 0.34 , 0.86 , 47.93 ) , {R}_{1} = 0.89 ,$$

$${Q}_{2} = diag ( 0.5 , 0.3 , 1 , 0.5 ) , {R}_{2} = 0.35 .$$

The parameters Q₁, R₁ in the velocity loop j=1 correspond to a robust control configuration chosen to minimize failure percentage in closed-loop performance metrics involving 100 ft/s step-velocity commands, consistent with performance metrics 401, design requirement 404, and table 1 405. To avoid bias against FBL, initial-condition ablation and closed-loop response evaluations likewise include analysis of 100 ft/s velocity-command responses. The outputs considered for FBL were y=[V, h]^{T}. For the FPA loop j=2, the parameters Q₂, R₂ satisfy the closed-loop performance specifications shown in design requirement 404, enabling numerical comparisons with FBL.

Nominal LQR and optimal LQR: To assess performance enhancements achieved by dEIRL relative to classical control designs, the closed-loop performance of the final dEIRL controller K_{i*,j} for each loop j=1, . . . , N was evaluated alongside two classical designs: the nominal LQR controller K_{0,j} and the optimal LQR controller

$${K}_{j}^{*} ,$$

which is optimal with respect to the modeling-error parameters ν. Quantitative comparisons include the policy-optimality error

$$‖ {K}_{{l}^{*} , j} - {K}_{j}^{*} ‖$$

versus the nominal LQR error

$$‖ {K}_{0 , j} - {K}_{j}^{*} ‖ ,$$

together with evaluations of frequency-response characteristics, time-domain behavior, and closed-loop robustness consistent with performance metrics 401, indicator function 403, and design requirement 404 in table 1 405.

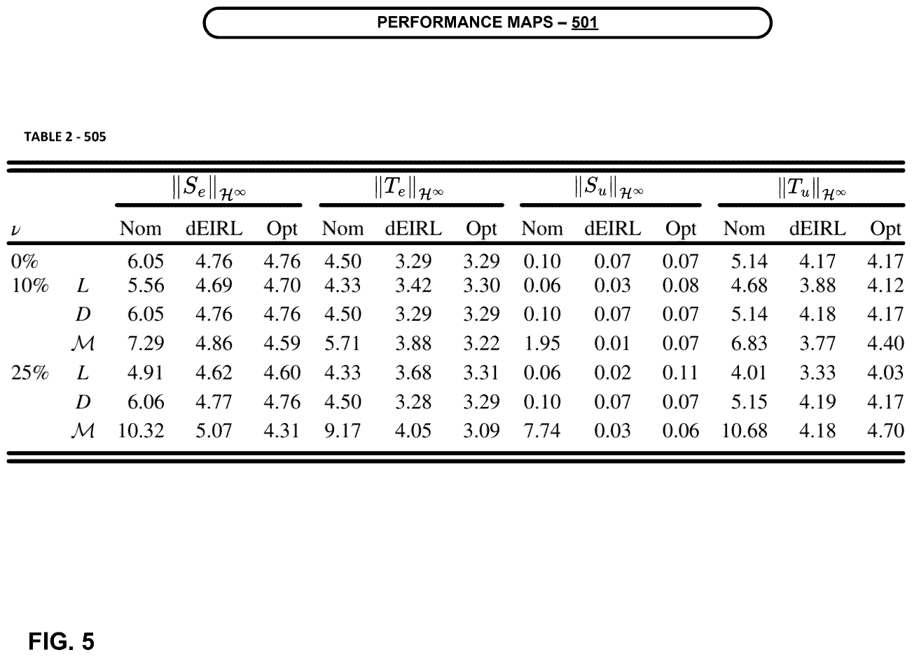

FIG. 5 depicts Table 2, at element 505, which is presented beneath performance maps 501, in accordance with aspects of the disclosure. Table 2 505 summarizes peak closed-loop performance maps generated under variations in modeling-error parameters ν in accordance with aspects of the disclosure. The entries of table 2 505 provide comparative evaluations of the nominal linear quadratic regulator (LQR) design, the dEIRL controller, and the uncertainty-optimal controller for each value of the modeling-error parameter ν. The evaluations focus on the peak magnitudes of four frequency-domain closed-loop operators expressed in the H∞ norm, denoted as ∥Sₑ∥^{H}∞, ∥Tₑ∥^{H}∞, ∥Sᵤ∥^{H}∞, and ∥Tᵤ∥^{H}∞.

For each modeling-error level ν shown in table 2 505, including nominal (0 percent), moderate (10 percent), and high (25 percent) uncertainty magnitudes, table 2 505 presents peak values across lift-coefficient uncertainty, drag-coefficient uncertainty, and moment-coefficient uncertainty. These uncertainty categories correspond to the uncertainty parameters introduced previously for the lift coefficient, drag coefficient, and pitch-moment coefficient, respectively. The rows labeled L, D, and M reflect these respective uncertainty directions at each magnitude of ν.

Across all uncertainty levels shown in table 2 505, the peak values of ∥Sₑ∥^{H}∞ and ∥Tₑ∥^{H}∞ indicate the degree to which the closed-loop system amplifies disturbances entering through the regulated output and the tracking error dynamics. The peak values of ∥Sᵤ∥^{H}∞ and ∥Tᵤ∥^{H}∞ provide corresponding amplification factors for disturbances acting on the control input channel. The tabulated comparisons demonstrate that the dEIRL controller frequently reduces peak closed-loop gains relative to the nominal LQR design and approaches or attains the uncertainty-optimal performance indicated in the Opt column of table 2 505.

The data of table 2 505 therefore quantify performance improvements associated with the dEIRL framework under varying degrees and directions of aerodynamic modeling error. Additional analyses showing time-domain closed-loop responses, controller optimality, and frequency-domain structure are described elsewhere herein and are supported by the peak H œ-norm results summarized in table 2 505 of FIG. 5.

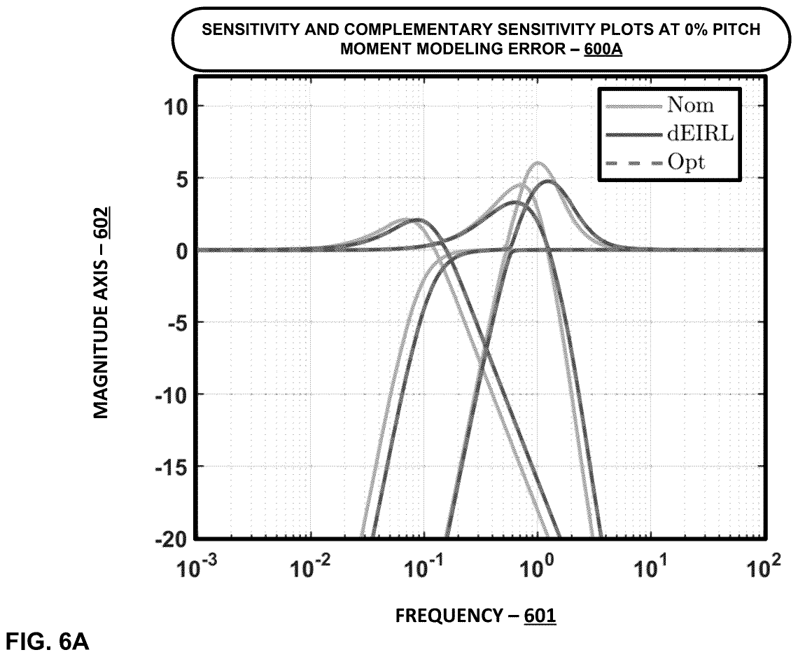

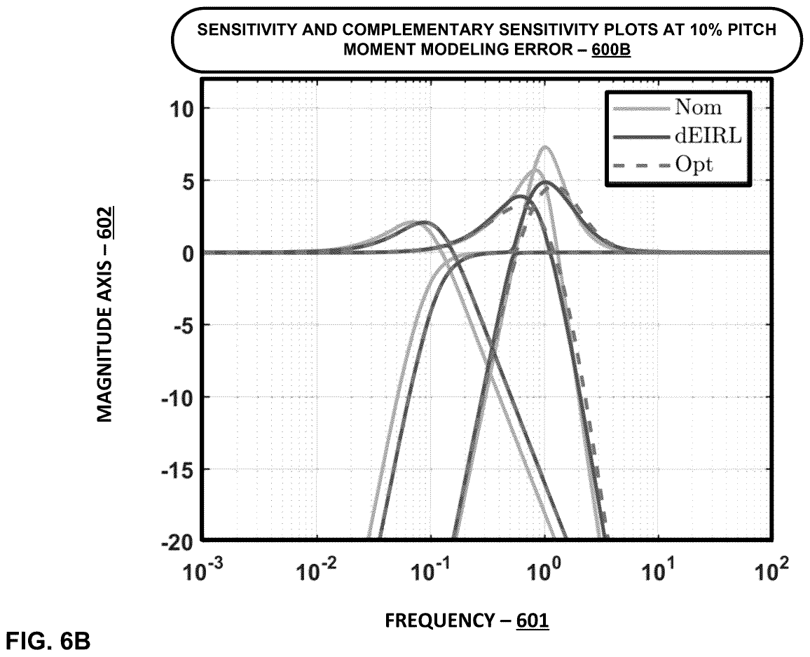

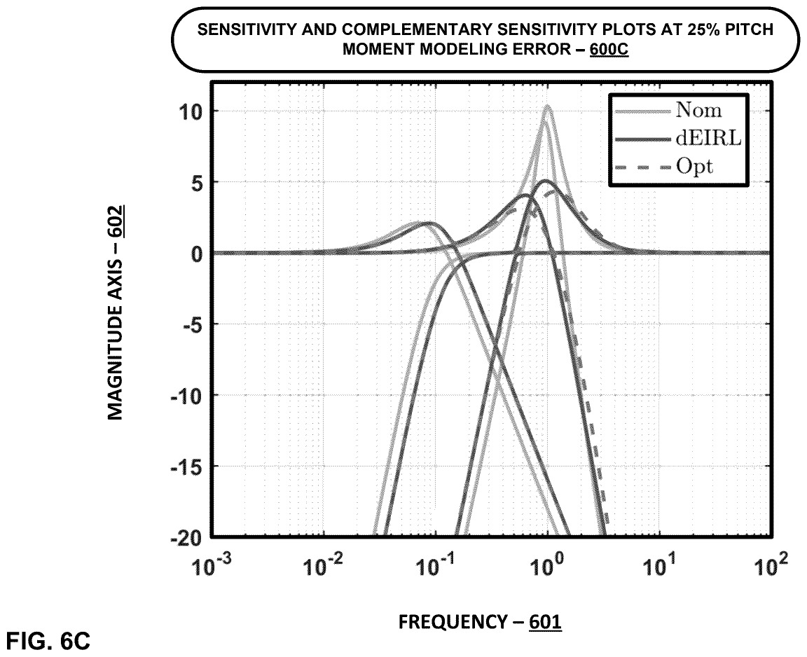

FIGS. 6A, 6B, and 6C depict charts showing sensitivity and complementary sensitivity frequency responses at the error with respect to variations in the pitch moment modeling error of Equation (8), in accordance with aspects of the disclosure. In particular, FIG. 6A depicts sensitivity and complementary sensitivity frequency responses using sensitivity and complementary sensitivity plots at 0% pitch moment modeling error 600A. FIG. 6A further illustrates magnitude axis 602 plotted against frequency 601. FIG. 6B depicts sensitivity and complementary sensitivity frequency responses using sensitivity and complementary sensitivity plots at 10% pitch moment modeling error 600B. FIG. 6B also illustrates magnitude axis 602 plotted against frequency 601. FIG. 6C depicts sensitivity and complementary sensitivity frequency responses using sensitivity and complementary sensitivity plots at 25% pitch moment modeling error 600C, and also illustrates magnitude axis 602 plotted against frequency 601.

Frequency response performance of the nominal linear quadratic (LQ) controller, distributed excitation integral reinforcement learning (dEIRL) controller, and optimal LQ controller was analyzed with respect to the sensitivity functions Sₑ and Sᵤ and the complementary sensitivity functions Tₑ and Tᵤ at the error and controls, respectively, as previously shown in FIG. 3. These frequency response maps were evaluated at 0%, 10%, and 25% modeling errors in lift coefficient ν_{L} of Equation (4), drag coefficient ν_{D} of Equation (6), and pitch moment coefficient ν_{M} of Equation (8). The peak closed-loop map data corresponding to these frequency responses is summarized in Table 2, as shown in FIG. 5. FIGS. 6A, 6B, and 6C illustrate the full frequency response curves of the sensitivity and complementary sensitivity functions Sₑ and Tₑ at the error with respect to variations in the pitch moment coefficient modeling error ν_{M}.

Examination of Table 2 indicates that regardless of the modeling error tested in ν_{L}, ν_{D}, or ν_{M}, and regardless of the severity of the modeling error between 0% and 25%, dEIRL successfully recovers the closed-loop frequency response properties of the optimal controller. For all modeling error types and values, dEIRL recovers the H^{∞} norm of the optimal controller for all frequency response maps to within 0.96 dB at maximum, with the worst case occurring in the complementary sensitivity at the error Tₑ for 25% pitch moment modeling error. In the absence of modeling error, the nominal LQ controller achieves closed-loop peaking comparable to dEIRL and the optimal controller at the controls, which is expected because these methods inherit linear quadratic regulator (LQR) performance guarantees at the controls. The nominal design's peaking in the sensitivity at the controls satisfies ∥Sᵤ∥_{H}_{^{∞}}≈0 dB, similar to the dEIRL and optimal controllers. LQR theory guarantees ∥Sᵤ∥_{H}_{^{∞}}≈0 dB, with slight numerical deviations arising from the decentralized controller structure. The nominal controller's peak in the complementary sensitivity at the controls satisfies ∥Tᵤ∥_{H}_{^{∞}}=5.14 dB, which is comparable to the dEIRL and optimal controllers at 4.17 dB. LQR theory guarantees ∥Tᵤ∥_{H}_{^{∞}}≤6 dB.

At the error, the nominal controller's peaking is generally comparable to that of dEIRL and the optimal controller for small modeling error, typically within 1 dB. Due to its accurate recovery of optimal closed-loop performance, dEIRL exhibits minimal degradation in peaking as modeling error increases. The largest observed increase in the H^{∞} norm for any map and modeling error type occurs for the complementary sensitivity at the error Tₑ with respect to pitch moment coefficient modeling error ν_{M}, where the dEIRL peak increases only 0.76 dB, from 3.29 dB at 0% modeling error to 4.05 dB at 25% modeling error.

In contrast, the nominal LQ controller experiences significant closed-loop performance degradation in the presence of modeling error. The degradation is most severe with respect to pitch moment coefficient modeling error ν_{M}, as illustrated at the error in FIGS. 6A, 6B, and 6C. The nominal controller's peaking increases substantially from 0% to 25% modeling error, rising from 6.05 dB to 10.32 dB for the sensitivity at the error Sₑ, and from 4.33 dB to 9.17 dB for the complementary sensitivity at the error Tₑ. Similar degradations are observed at the controls, as summarized in Table 2.

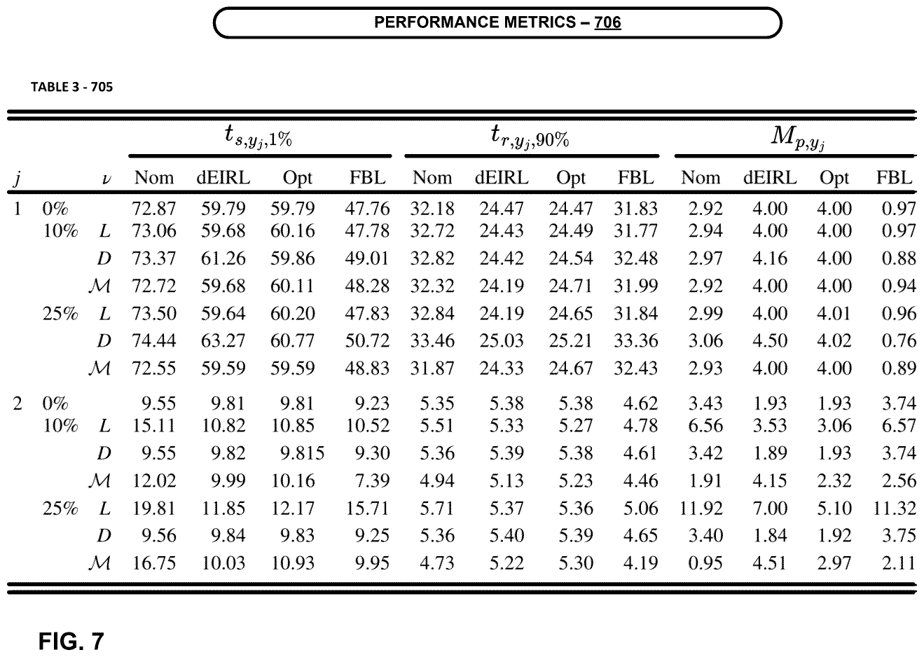

FIG. 7 depicts Table 3, at element 705, summarizing step-response performance metrics versus modeling error ν for compared methods, in accordance with aspects of the disclosure.

Closed-loop step-response performance generalization to modeling error: an examination is provided regarding how closed-loop step-response characteristics for the tested methods (nominal LQR, dEIRL, optimal LQR, and FBL) generalize with respect to increasing modeling error ν. Table 705 displays the 1% settling time tₛ_{ⱼ}_{,1%}, the 90% rise time t_{r,y j,90%}, the percent overshoot M_{p,y}_{ᵢ} when issuing a step-reference command in velocity j=1(y₁=V) and FPA j=2(y₂=γ) for the tested methods. These step responses are issued at 0%, 10%, and 25% modeling errors in lift coefficient ν_{L} of Equation (4), drag coefficient ν_{D} of Equation (6), and pitch-moment coefficient [symbol] of Equation (8).

Step Velocity Command: Overall, the velocity closed-loop step-response performance remains favorable with respect to varying modeling errors. All methods maintain a 1% settling time in velocity t_{s,V,1%} of less than 75 s and a 90% rise time in velocity t_{r,V,90%} of less than 35 s, regardless of the modeling error type or severity. Percent overshoot also remains low at less than 5% for all methods, with the lowest being FBL at approximately 1%, followed by the nominal at approximately 3%, and dEIRL and the optimal at approximately 4%. Notably, dEIRL recovers the closed-loop velocity command, following the properties of the optimal controller. Regardless of the modeling error introduced, dEIRL's 1% rise time remains within 2.50 s of the optimal (a 4.1% change), the 90% settling time within 0.52 s of the optimal (a 2.0% change), and the percent overshoot within 0.48% of the optimal (an 11.9% change). Deviations in FPA due to step velocity commands are minimal for all methods, remaining less than 0.04° at maximum, and peak elevator deflection deviation δ_{E} from trim remains less than 1°. It is notable that decentralized excitable integral reinforcement learning (dEIRL), the optimal controller, and feedback linearization (FBL) all use similar throttle control effort δ_{T}, whose peaks reach on the order of 0.35-0.4, depending on the modeling error, and remain within ±0.02 of each other between the three methods. The nominal LQR design uses less control effort, peaking between 0.31 and 0.36. This comes at the cost of increased settling time (approximately 73 s for the nominal design versus approximately 60 s for dEIRL and the optimal and approximately 50 s for FBL), thus resulting in a tradeoff between settling time and control effort. However, all methods remain within the 75 s velocity settling time, as specified in the specification above.

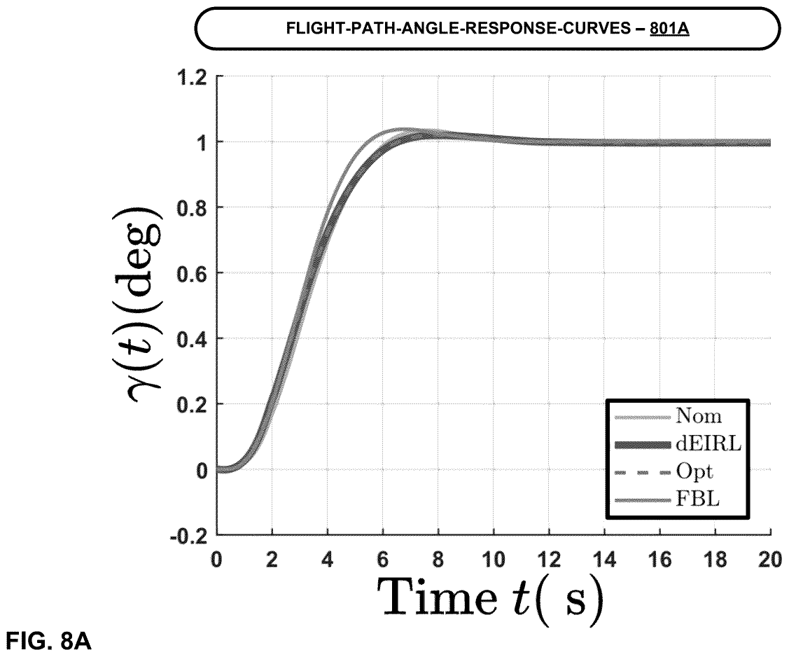

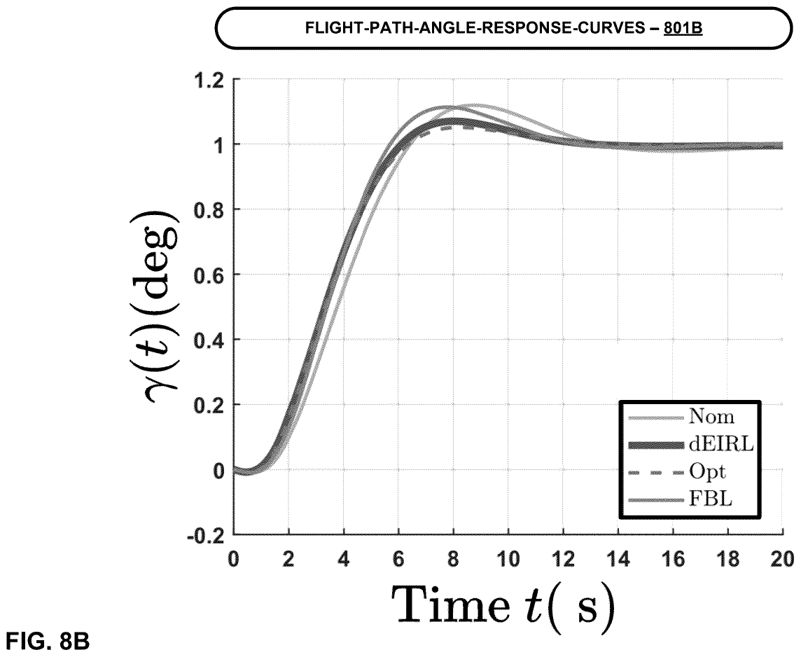

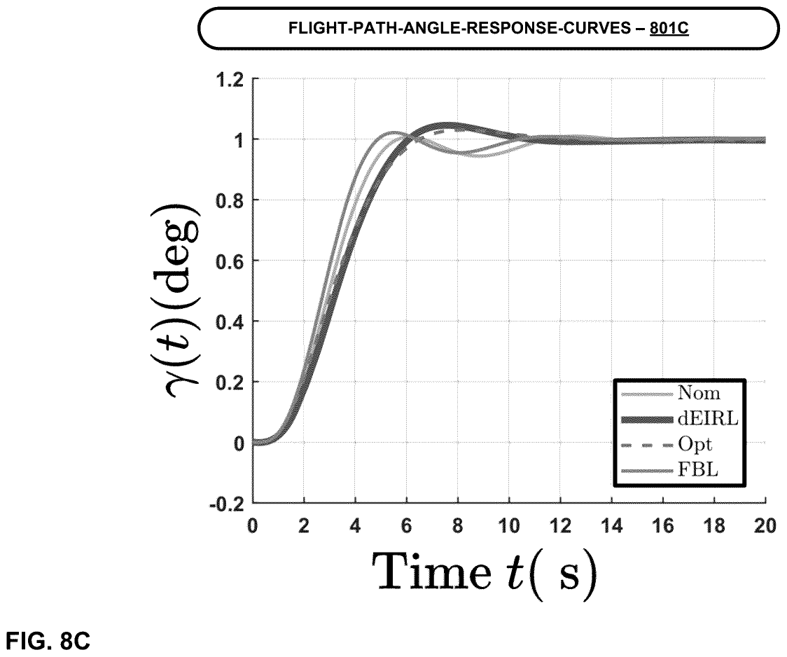

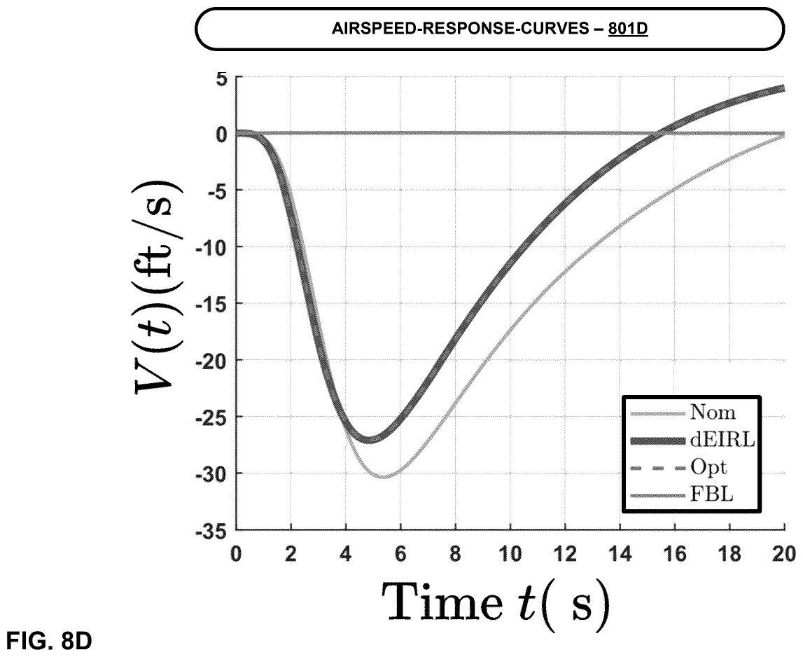

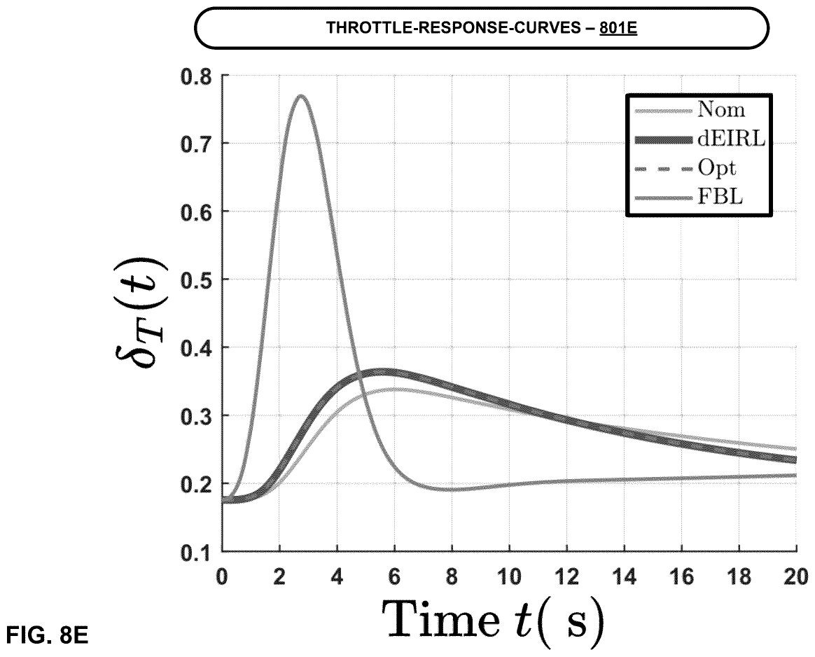

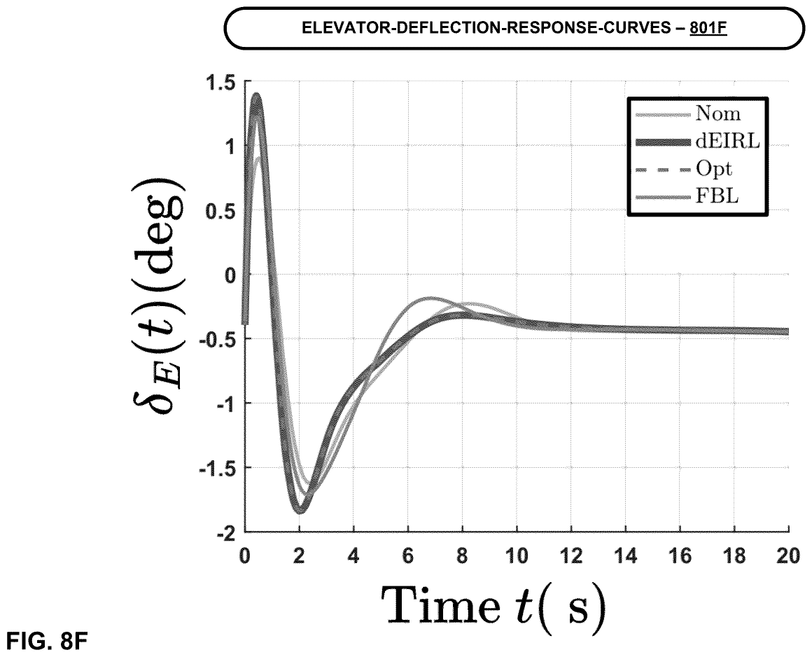

FIGS. 8A, 8B, 8C, 8D, 8E, and 8F depict charts showing closed-loop response to step FPA commands, in accordance with aspects of the disclosure. In particular, FIG. 8A presents flight-path-angle response curves—801A FPA γ for the nominal model; FIG. 8B presents flight-path-angle response curves—801B FPA γ for 25 percent modeling error in the lift coefficient; FIG. 8C presents flight-path-angle response curves—801C FPA γ for 25 percent modeling error in the pitch-moment coefficient; FIG. 8D presents airspeed-response curves-801D velocity V; FIG. 8E presents throttle-response curves—801F throttle δ_{E}; and FIG. 8F presents elevator-deflection-response curves—801F elevator δ_{F}. Together, these figures illustrate the effects of aerodynamic modeling error ν on closed-loop step-FPA command tracking for the nominal LQR controller, the dEIRL controller, the uncertainty-optimal LQR controller, and the FBL controller.

Step FPA Command: Comparatively speaking, closed-loop performance degradation is more pronounced in the FPA response, with dEIRL and the optimal exhibiting a performance edge over the nominal and FBL. Nominally, all methods achieve the original performance specified above of a 1% FPA settling time t_{s,γ,1%}≤10 s and percent overshoot M_{p,γ}<5%. The 90% FPA rise time t_{r,γ,90%} is also low at less than 5.5 s for all methods. Intuitively, the closed-loop FPA performance degrades less for modeling errors in the drag coefficient (which primarily affects the velocity dynamics); however, lift and pitching moment coefficient errors significantly impact performance. For instance, from 0% to 25% lift coefficient modeling error, the 1% settling time t_{s,γ,1%} increases to 19.81 s (a +75% change) for the nominal LQR and 15.71 s (+70%) for FBL, taking these methods well out of the 10 s design specification. Meanwhile, degradation for dEIRL and the optimal LQR is less pronounced at 11.85 s (+21%) and 12.17 s (+24%), respectively. From this same 0% to 25% lift coefficient modeling error, percent overshoot in FPA M_{p,γ} increases to 11.92% for the nominal LQR and 11.32% for FBL. Meanwhile, dEIRL increases to only 7.00% and the optimal LQR to 5.10%.

Elevator control effort to a step FPA command is comparable among all methods, typically remaining within ±2 deg (see FIG. 8F). For the nominal system, FBL exhibits virtually zero deviations in velocity in its response to a step FPA command; meanwhile, the nominal, dEIRL, and optimal controllers all feature a velocity dip transient of 25-30 ft/s in their responses. The near-zero velocity deviations achieved by FBL are a direct result of its decoupling inversion of the system dynamics, which guarantees that the output in the velocity channel remains unaffected by commands issued in the FPA channel. However, when modeling error is introduced, the FBL controller no longer achieves exact dynamic inversion, resulting in velocity dips of up to 15 ft/s in amplitude. Furthermore, this decoupling inversion of the velocity dynamics requires a large control effort in the throttle channel δ_{T}, a phenomenon in FBL generally and observed on the HSV model of HSV framework 170 (see FIG. 8E). Peak throttle setting for the nominal, dEIRL, and optimal controllers as a result of issuing a step FPA command is comparable at 0.35-0.4. Meanwhile, FBL's throttle peaks at 0.75 nominally, and by up to 1.05 when modeling error is introduced.

Notably, when a severe 25% pitch moment coefficient modeling error [symbol] is introduced, the percent overshoot of the nominal LQR (0.95%) and FBL (2.11%) outperforms that of dEIRL (4.51%) and the optimal LQR (2.97%). However, examination of FIG. 8C shows the reason for the lower percent overshoot achieved by the nominal LQR and FBL: Both of these controllers exhibit an undesirable inverse FPA response occurring after the overshoot, resulting in an FPA undershoot before the response settles. On the other hand, dEIRL and the optimal LQR do not exhibit such inverse behavior and maintain responses qualitatively similar to the nominal model response.

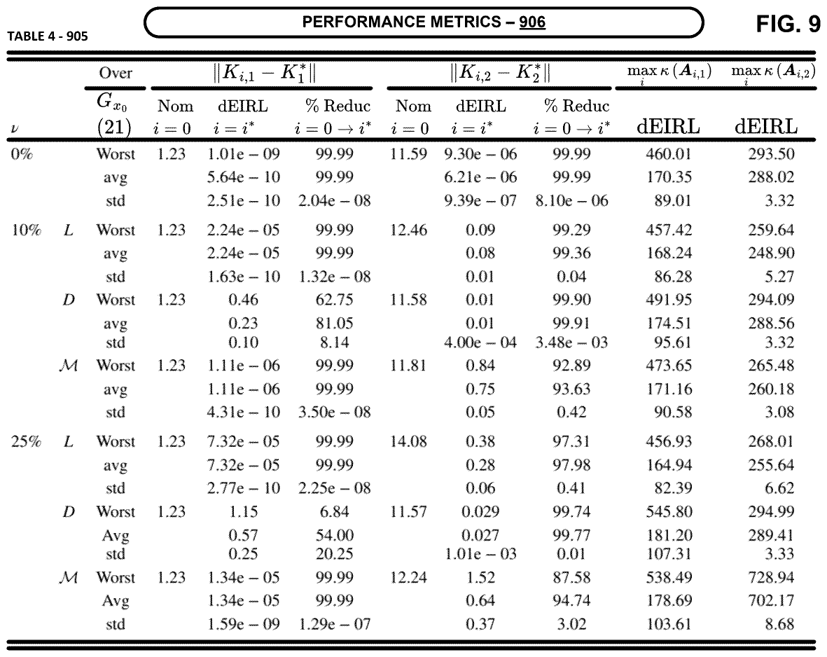

FIG. 9 depicts Table 4, set forth at element 905, summarizing the dEIRL optimality error and conditioning data due to ablations of initial condition x₀, in accordance with aspects of the disclosure. In particular, FIG. 9 depicts table 4 905, which summarizes performance metrics 906 associated with the dEIRL framework under variations in the initial condition X₀. Table 4 905 presents quantitative evaluations of the controller optimality error and the conditioning characteristics of the learning regression matrices generated across learning iterations. Performance metrics 906 include the dEIRL controller optimality errors ∥K_{i,1}−K₁*∥ and ∥K_{i,2}−K₂*∥, the conditioning values associated with the maximum algorithm condition numbers

$${max}_{i} κ ( {A}_{i , 1} ) and {max}_{i} κ ( {A}_{i , 2} ) ,$$

and corresponding percentage reductions in policy-error magnitudes as the iterative learning process progresses.

Table 4 905 evaluates these metrics under ablations of the initial condition X₀, which were generated using the initial-condition grid described previously. For each initial-condition selection in the ablation set, performance metrics 906 report worst-case, average, and standard-deviation values for the optimality-error norms and conditioning values. These metrics characterize the sensitivity of the decentralized learning process to variations in x₀ and quantify how changes in velocity and flight-path-angle initialization influence learning convergence, critic-matrix conditioning, and the numerical stability of regression matrices formed during the dEIRL update process.

Performance metrics 906 illustrate that dEIRL reduces the decentralized controller-parameter error substantially across the tested initial-condition ranges. The columns associated with

$$‖ {K}_{i , 1} - {K}_{1}^{*} ‖ and ‖ {K}_{i , 2} - {K}_{2}^{*} ‖$$

in table 4 905 show that dEIRL consistently decreases policy-error magnitudes relative to the initial stabilizing controller K₀, with percentage-reduction entries indicating the corresponding decrease in controller-parameter deviation after the i* learning iterations. The table also shows the influence of initial-condition offsets on conditioning values associated with κ(A_{i,1}) and κ(A_{i,2}), which provide numerical indicators of persistence-of-excitation characteristics for the learning data.

The conditioning values shown in table 4 905 reflect the maximum condition numbers observed across the learning iterations for each initial-condition sample and illustrate how variations in X₀ affect the degree of excitation present in the collected trajectory data. These results highlight that well-excited trajectories yield more favorable conditioning values and support reliable convergence toward K₁* and K₂*, whereas initial conditions that produce lower excitation may increase κ(Aᵢ_{ᵢ}_{,j}), consistent with the properties of data-dependent continuous-time learning regressions. The aggregated worst-case, average, and standard-deviation metrics indicate the robustness of dEIRL learning performance with respect to initial-condition variability.

Accordingly, table 4 905 and performance metrics 906 demonstrate how decentralized excitable integral reinforcement learning responds to variations in initial condition x₀ and quantify the resulting effects on policy-optimality error, conditioning behavior, and the numerical informativeness of the learning dataset across the tested ablation grid.

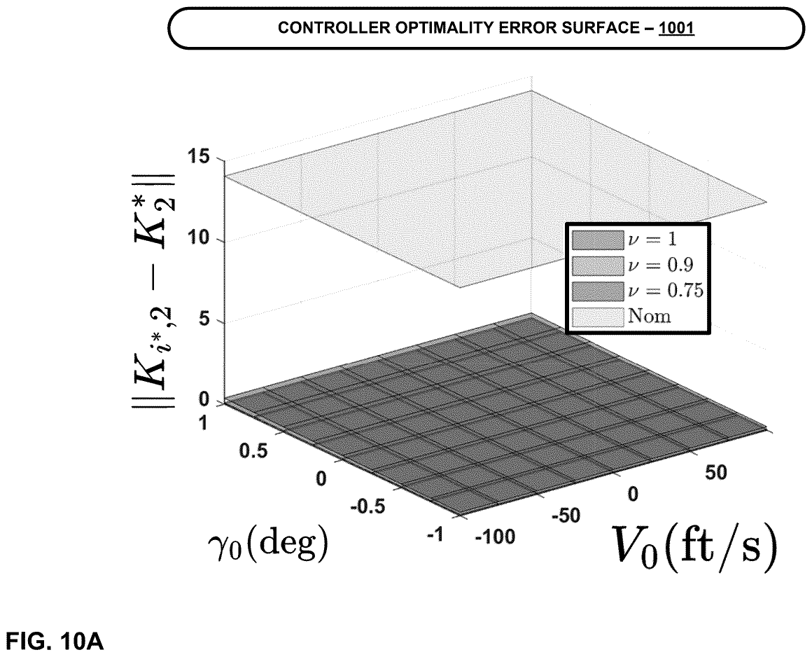

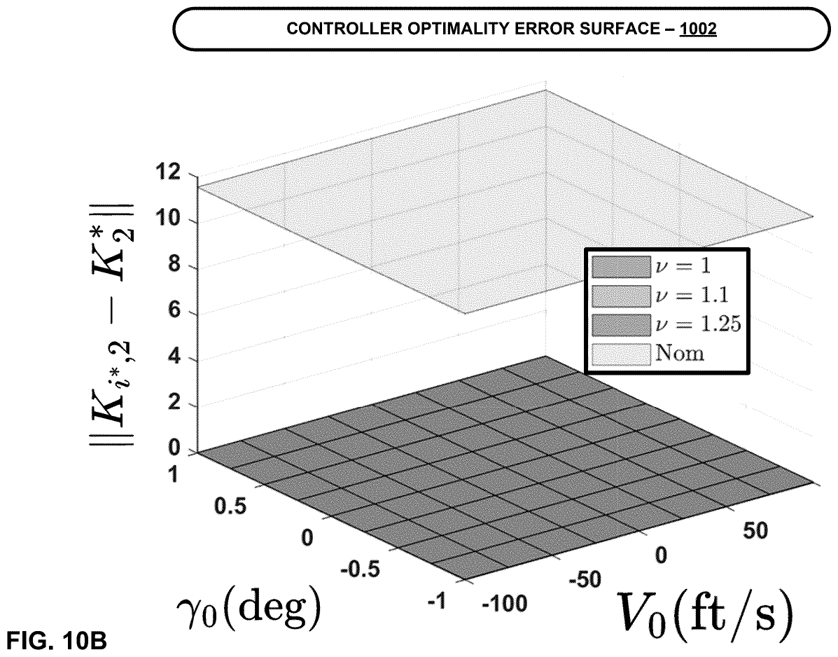

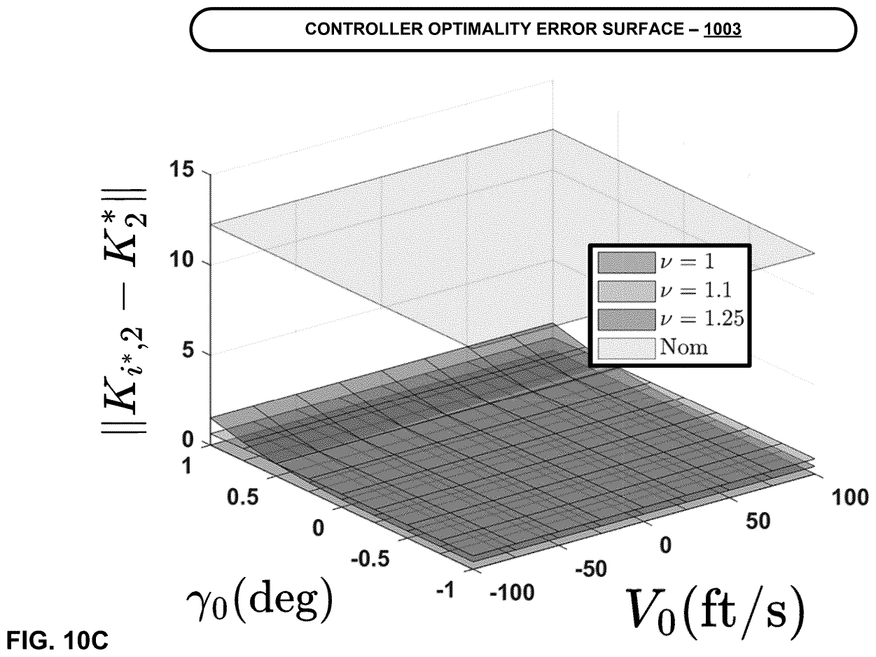

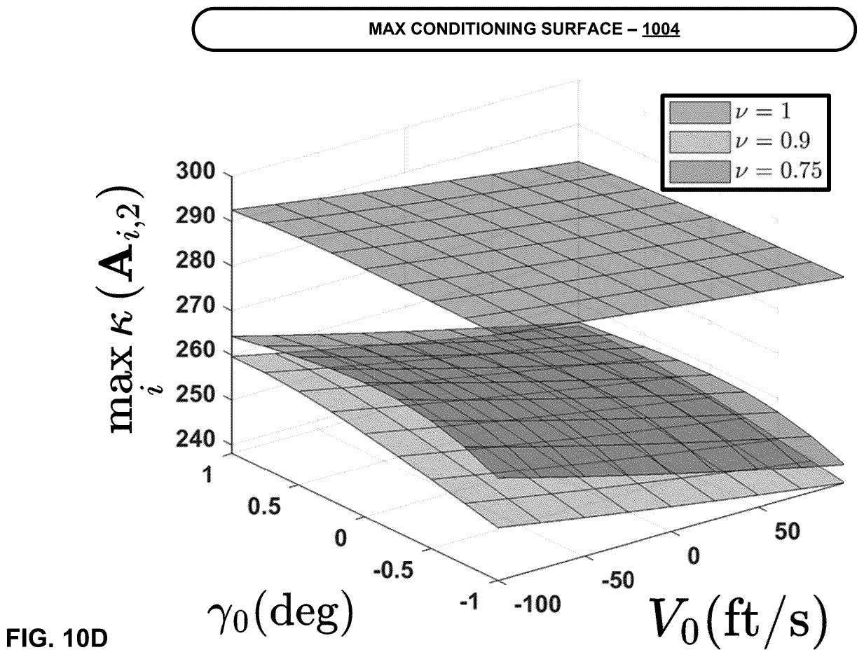

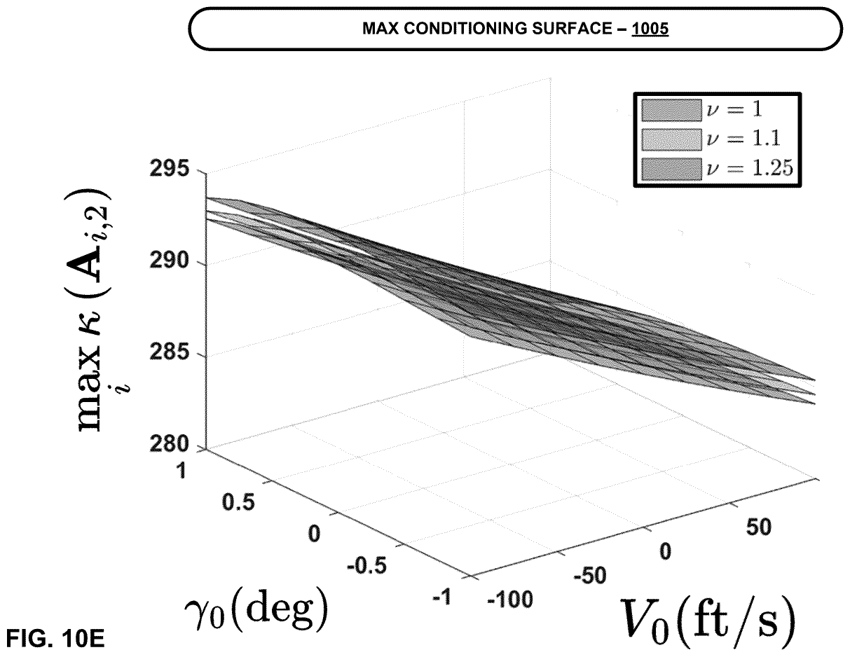

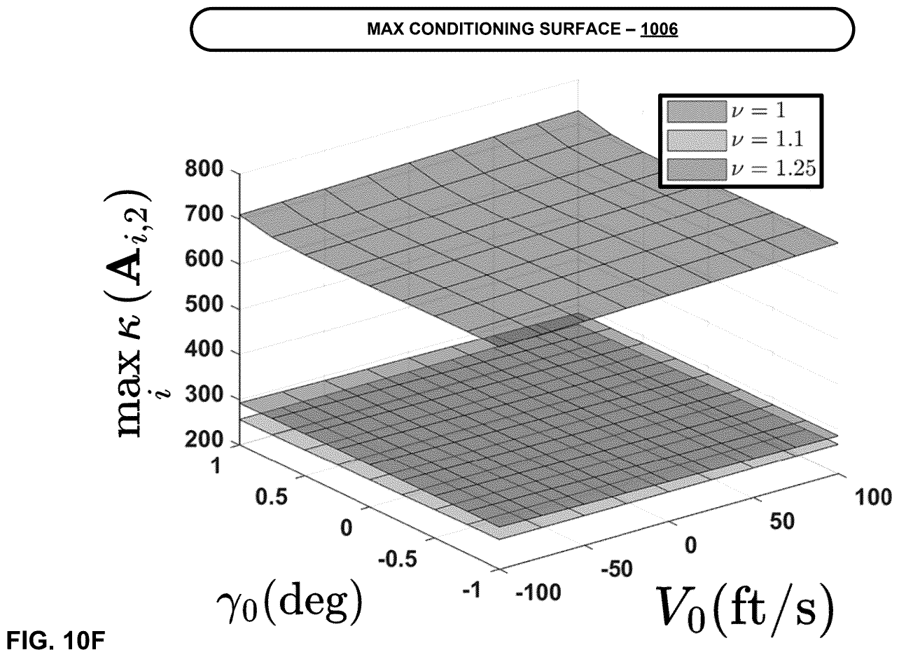

FIGS. 10A, 10B, 10C, 10D, 10E, and 10F depict charts showing the dEIRL controller optimality error

$$‖ {K}_{{i}^{*} , 2} - {K}_{2}^{*} ‖$$

and worst conditioning

$${max}_{i} κ ( {A}_{i , 2} )$$

versus IC x₀ and varying modeling error, in accordance with aspects of the disclosure. In particular, FIGS. 10A-10F depict charts generated using controller optimality error surface 1001, controller optimality error surface 1002, controller optimality error surface 1003, max conditioning surface 1004, max conditioning surface 1005, and max conditioning surface 1006. Each of these elements visualizes dEIRL behavior as a function of initial-condition perturbations and modeling-error variations within the lift, drag, and pitch-moment aerodynamic-coefficient parameters described previously.

Controller optimality error surface 1001, controller optimality error surface 1002, and controller optimality error surface 1003 present three-dimensional surfaces expressing the dEIRL controller-parameter deviation ∥Kᵢ₂−K₂∥ for the rotational subsystem j=2 with respect to variations in the initial-condition grid G₍ₓ₀₎. The surfaces are plotted over the velocity-offset axis V₀ and the flight-path-angle-offset axis γ₀, which represent the same initial-condition ablations introduced in conjunction with table 4 905. In each of these figures, the displayed surfaces correspond to several values of the modeling-error parameter ν selected from the lift-coefficient, drag-coefficient, and pitch-moment-coefficient uncertainty sets described previously. The color-shaded mesh panels contained within controller optimality error surface 1001, controller optimality error surface 1002, and controller optimality error surface 1003 illustrate how the dEIRL rotational-loop policy-error magnitude responds to simultaneous variations in x₀ and modeling-error values.

For each of these surfaces, larger values of ∥Kᵢ₂−K₂∥ indicate greater deviation between the learned controller and the optimal LQ controller K₂*. The plotted gradients demonstrate that the decentralized learning process remains robust across the majority of the initial-condition domain, with modest increases in error magnitude near the extremal values of V₀ and γ₀. This behavior is consistent with the tabulated worst-case and average policy-error values shown in table 4 905, which quantify the sensitivity of rotational-loop learning performance to x₀ ablations. The surfaces illustrate that when modeling-error magnitudes are increased, particularly when ν is perturbed in the direction of decreasing the RHPZ/RHPP ratio, the controller-parameter deviation becomes more pronounced, yet still retains convergence toward K₂* across the tested range.

Max conditioning surface 1004, max conditioning surface 1005, and max conditioning surface 1006 present the corresponding conditioning characteristics of the decentralized dEIRL regression matrices associated with the rotational loop. These elements each depict a three-dimensional surface of the maximum algorithm condition number (max)ᵢK(Aᵢ₂), plotted across the same initial-condition axes V₀ and γ₀ and for the same family of modeling-error values. The conditioning surfaces characterize how informative the learning data are under the decentralized update formulation, as improved conditioning correlates with enhanced persistence of excitation for the nonlinear trajectory data described earlier.

Max conditioning surface 1004, max conditioning surface 1005, and max conditioning surface 1006 exhibit elevated condition numbers near regions of reduced excitation, particularly when γ₀ approaches its extremal values or when modeling-error values ν reduce the contribution of stabilizing aerodynamic derivatives. These effects align with the conditioning behavior documented in table 4 905, which reports worst-case, mean, and standard-deviation statistics for κ(Aᵢⱼ) across the initial-condition ablations. As shown in these surfaces, well-excited trajectories near moderate values of V₀ and γ₀ generally yield lower condition numbers, a phenomenon consistent with the multi-injection (MI) and modulation-enhanced excitation (MEE) mechanisms described previously.

Taken together, controller optimality error surface 1001, controller optimality error surface 1002, controller optimality error surface 1003, max conditioning surface 1004, max conditioning surface 1005, and max conditioning surface 1006 provide spatial visualization of how initial-condition variation and modeling-error parameters influence both controller-parameter convergence and numerical conditioning within the decentralized dEIRL process. These figures further illustrate that the decentralized learning algorithm maintains robust convergence characteristics and favorable conditioning properties across a broad range of initial-condition offsets, consistent with the quantitative findings presented in table 4 905.

FIGS. 10A, 10B, 10C, 10D, 10E, and 10F depict charts showing the dEIRL controller optimality error

$$‖ {K}_{{i}^{*} , 2} - {K}_{2}^{*} ‖$$

and worst conditioning

$${max}_{i} κ ( {A}_{i , 2} )$$

versus IC x₀ and varying modeling error, in accordance with aspects of the disclosure. In particular, FIGS. 10A-F depict charts generated using controller optimality error surface 1001, controller optimality error surface 1002, controller optimality error surface 1003, max conditioning surface 1004, max conditioning surface 1005, and max conditioning surface 1006, showing the dEIRL controller optimality error

$$‖ {K}_{{i}^{*} , 2} - {K}_{2}^{*} ‖ .$$

FIG. 10D depicts worst conditioning

$${max}_{i} κ ( {A}_{i , 2} )$$

versus IC x₀ and varying modeling error in lift ν_{L}. FIG. 10E depicts worst conditioning

$${max}_{i} κ ( {A}_{i , 2} )$$

versus IC x₀ and varying modeling error in drag ν_{D}. And FIG. 10F depicts worst conditioning

$${max}_{i} κ ( {A}_{i , 2} )$$

versus IC x₀ and varying modeling error in pitch moment [symbol] .

Performance of dEIRL-Initial Condition Ablation Study: For the initial condition ablation study, HSV framework 170 executed dEIRL for each initial condition over the IC x₀∈Gₓ_{₀} of Equation (21), and at varying modeling errors 0-25% in each of the modeling error grids G_{ν}_{_{L}}, G_{ν}_{_{D}}, and [symbol] of Equation (20), resulting in a total of 2511 independent learning trials. Table 4 (see FIG. 9) displays the nominal controller optimality error

$$‖ {K}_{0 , j} - {K}_{j}^{*} ‖ ,$$

dEIRL's optimality error

$$‖ {K}_{{i}^{*} , j} - {K}_{j}^{*} ‖ ,$$

and the percent reduction in optimality error from nominal→dEIRL (i.e., i=0→i*) in each loop j=1 (velocity V) and j=2 (FPA γ) for the IC sweep. Table 4 (see FIG. 9) also includes dEIRL's iteration-wise maximum learning regression conditioning

$${max}_{i} κ ( {A}_{i , j} ) , j = 1 , 2 .$$

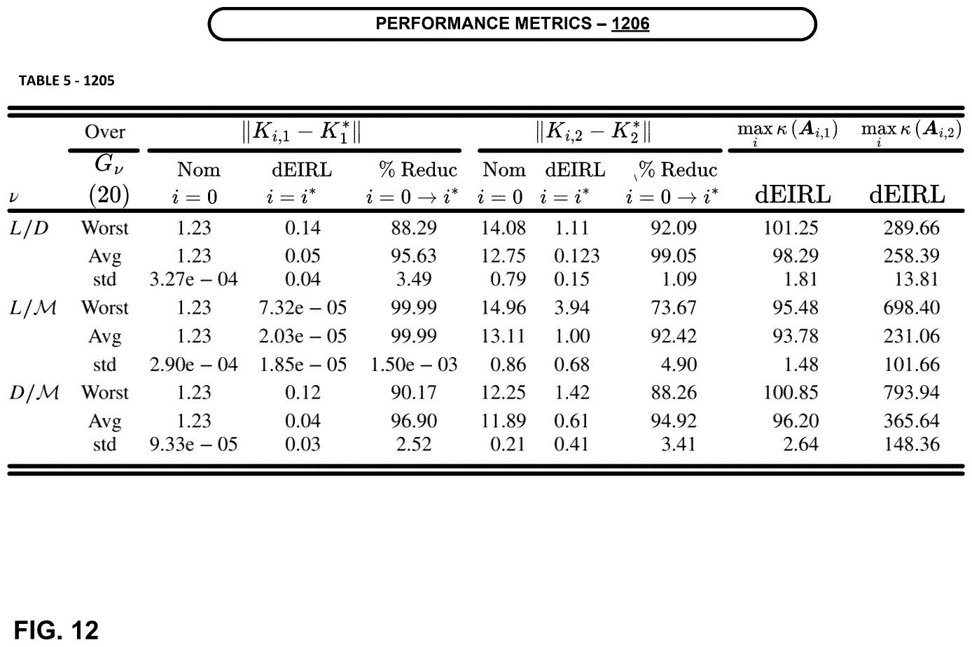

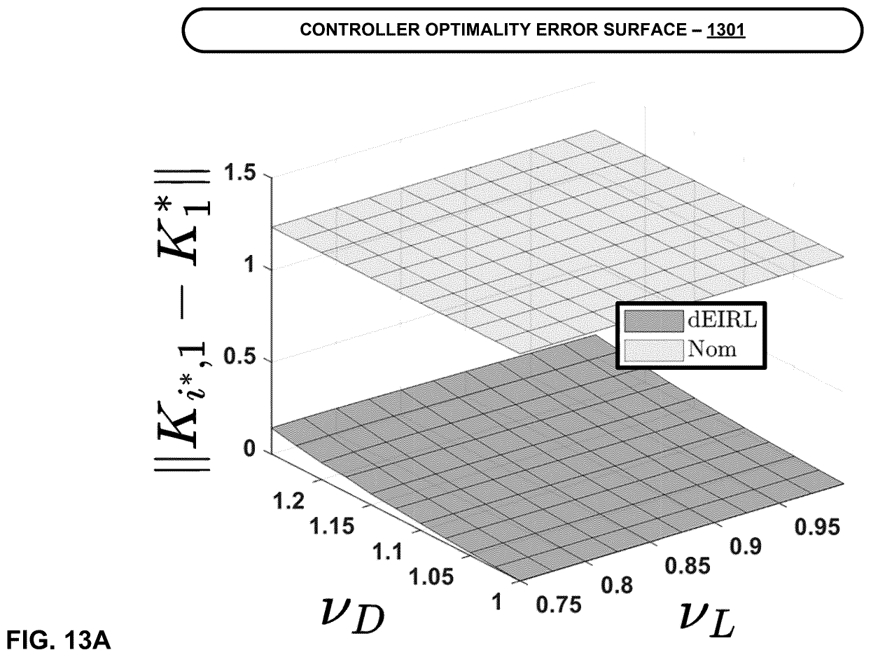

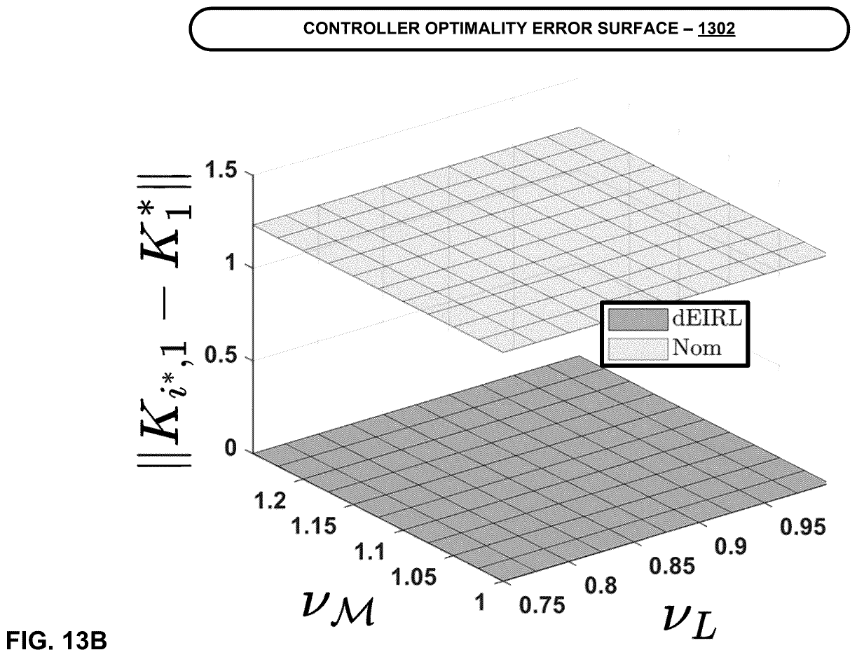

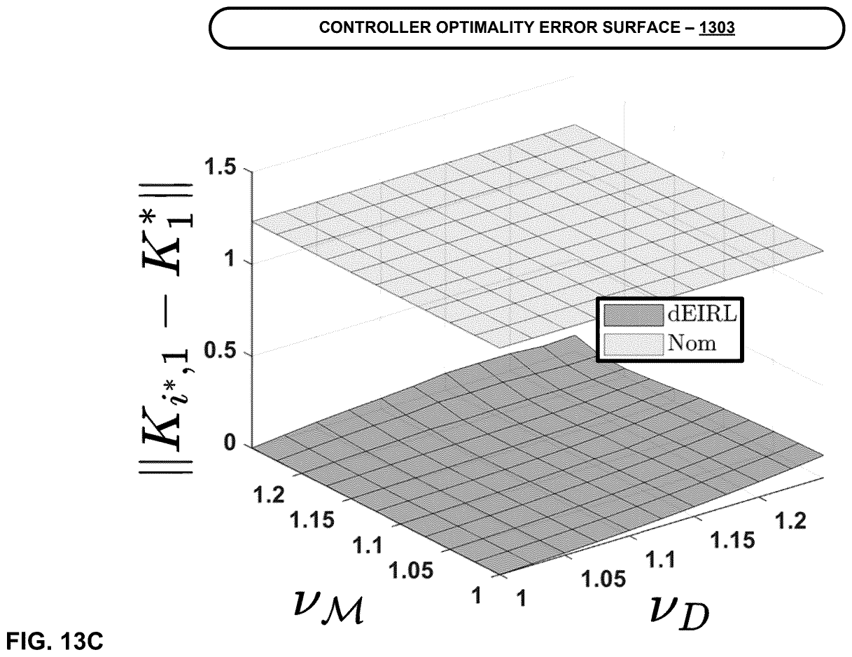

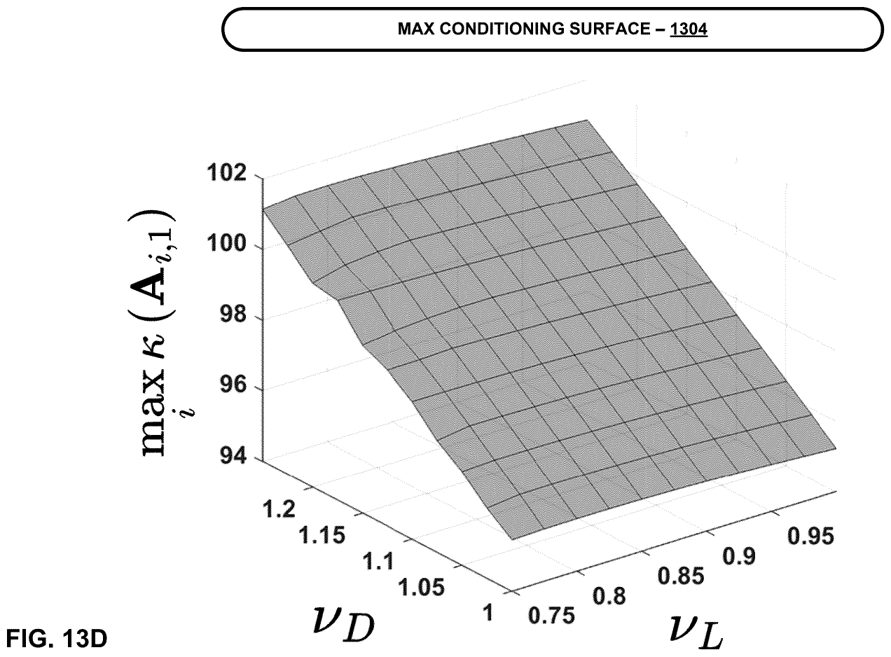

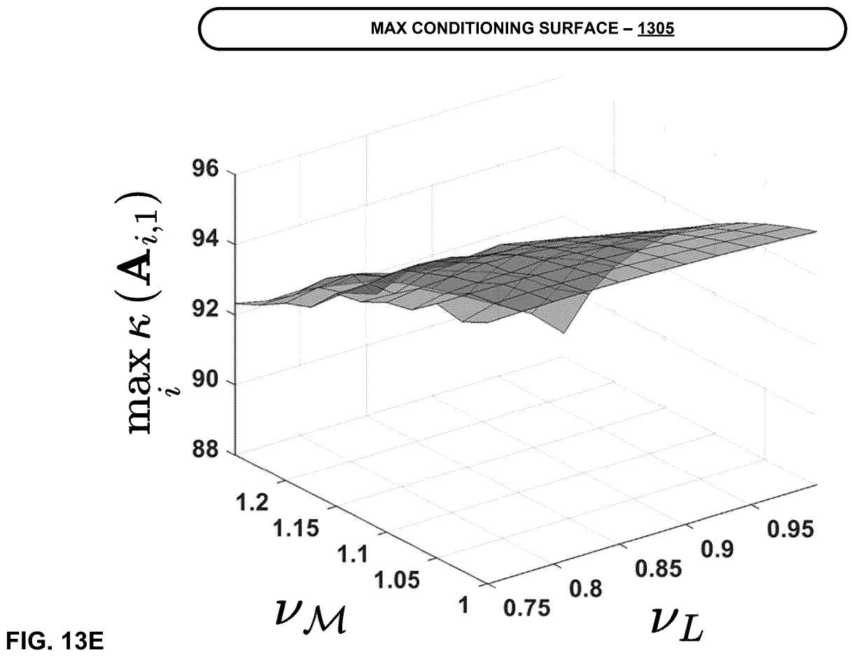

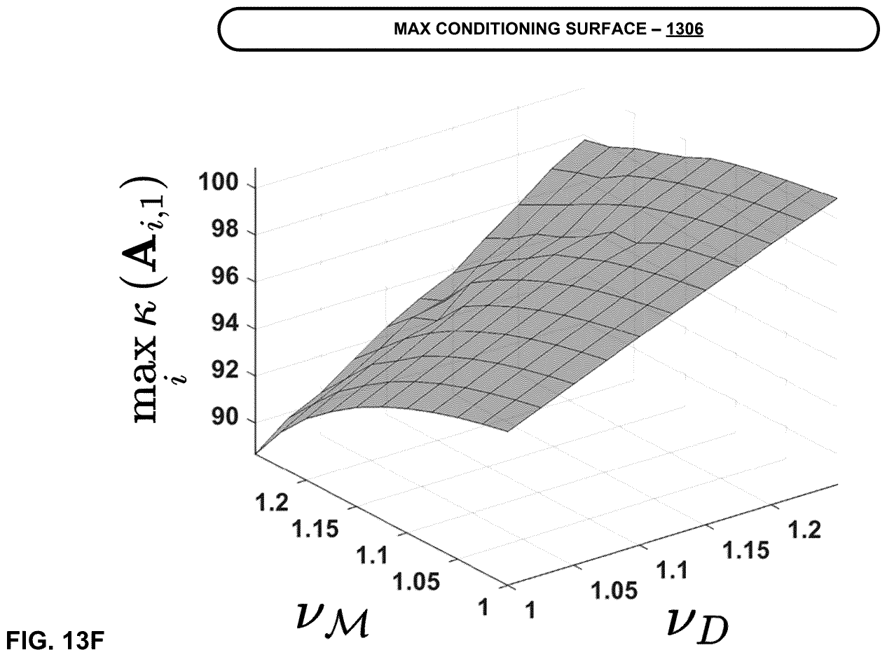

All performance measures include worst, average, and standard deviation data (each taken over the IC grid x₀∈Gₓ_{₀}). The controller optimality error and conditioning data presented in Table 5 (see FIG. 12) is visually plotted in FIGS. 13A-13F for the velocity loop j=1.

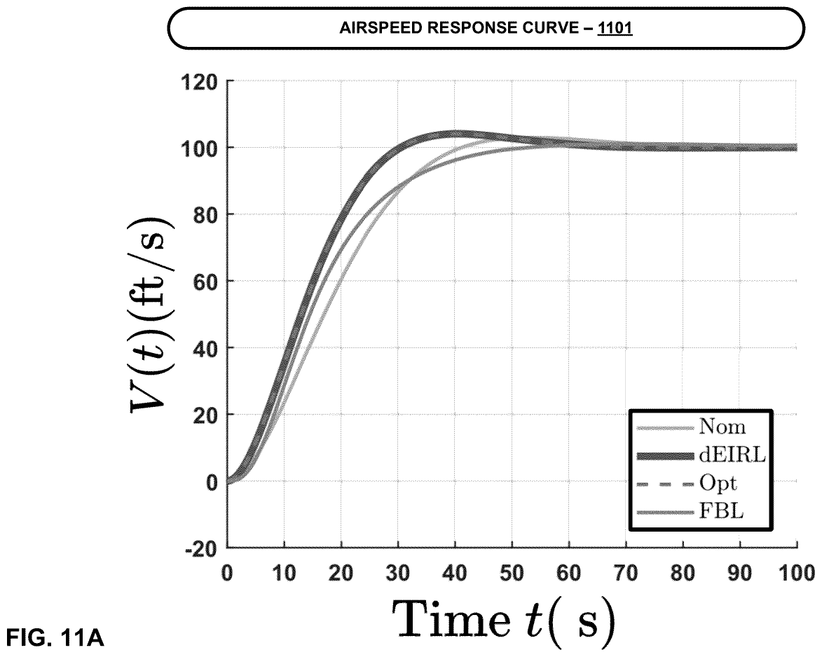

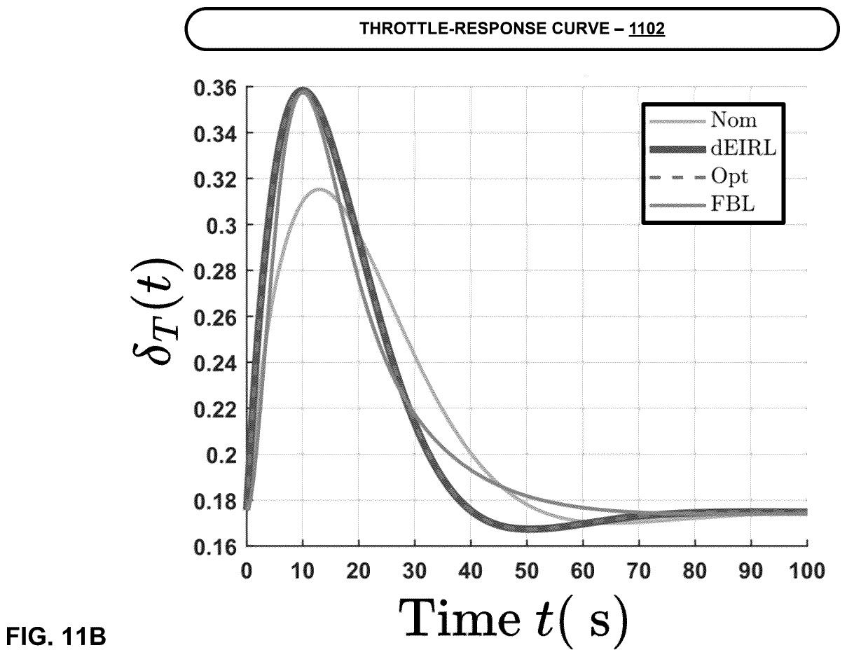

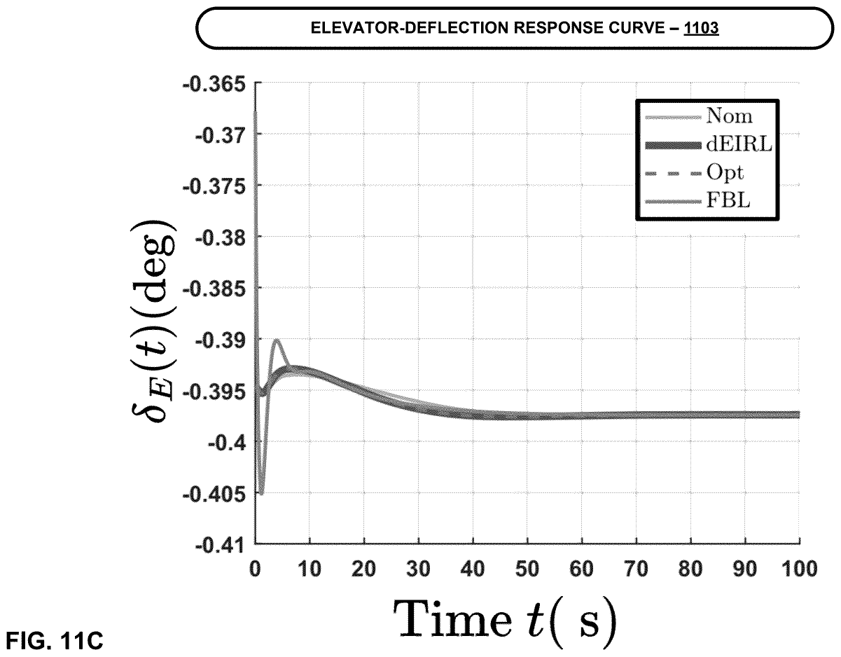

FIGS. 11A, 11B, and 11C depict charts showing nominal model closed-loop response to step velocity command, in accordance with aspects of the disclosure. In particular, FIG. 11A depicts airspeed response curve 1101, velocity V. FIG. 11B depicts throttle-response curve 1102, throttle δ_{T}. And FIG. 11C depicts elevator-deflection-response curve 1103, elevator δ_{E}.

Solution Optimality Under Modeling Error: Table 4 (see FIG. 9) and FIGS. 11A, 11B, and 11C depict that, regardless of the modeling error type tested (in lift ν_{L}, drag ν_{D}, or pitching moment [symbol] ), and regardless of the severity of the modeling error (0-25%), dEIRL successfully recovers optimality of the controller in each loop j=1, 2 for all initial conditions tested in the grid x₀∈Gₓ_{₀}; i.e., dEIRL achieves small optimality error

$$‖ {K}_{{i}^{*} , j} - {K}_{j}^{*} ‖ .$$

Indeed, regardless of the IC, modeling error type, and modeling error value tested, dEIRL's controller optimality error

$$‖ {K}_{{i}^{*} , j} - {K}_{j}^{*} ‖ .$$

remains within 1.52 in both loops j=1, 2. It is intuitive that the worst-case of 1.52 occurs in the higher-dimensional, unstable, nonminimum phase FPA loop j=2 at the most severe 25% pitch moment coefficient [symbol] modeling error tested. By contrast, the nominal LQR controller's respective optimality error is

$$‖ {K}_{0 , 2} - {K}_{2}^{*} ‖ = 12.24 ,$$

almost a factor of 10 larger.

In the evaluations of HSV framework 170, dEIRL achieved significant percent reductions in controller optimality error relative to the nominal LQR design, even for severe modeling errors. For example, at 25% modeling error in the more dynamically challenging FPA loop j=2, dEIRL achieves a worst-case percent reduction from nominal to dEIRL over the IC grid x₀∈Gₓ_{₀} of 97.31% for lift coefficient modeling error ν_{L}, 99.74% for drag ν_{D}, and 87.58% for pitch moment [symbol] . Thus, dEIRL exhibits excellent learning generalization with respect to varying system initial conditions x₀, even in the face of severe model uncertainty. Furthermore, for the recovery of controller optimality, a designer is at least a factor of 10 times better off from running dEIRL than opting for a nominal classical LQR design.

The exception observed to this rule is in examining drag coefficient modeling error VD in the velocity loop j=1; intuitively, drag modeling error is observed to have the greatest effect on dEIRL's performance in the velocity loop of the types tested. At 10% drag coefficient modeling error, dEIRL reduces optimality error by 62.75% relative to the nominal at worst-case, 81.05% on average. At 25% drag coefficient modeling error, dEIRL reduces optimality error by only 6.84% in the worst case. Even so, dEIRL achieves an average reduction of 54% for this modeling error (a factor of two reduction), still a marked improvement in closed-loop performance relative to the nominal classical design.

Algorithm Conditioning Generalization: Note that dEIRL's conditioning remains highly consistent with respect to varying system initial conditions x₀∈Gₓ_{₀}, demonstrating good IC learning generalization. In the velocity loop j=1, conditioning maxes on the order of 460-470 at worst-case over the IC grid for all modeling error types ν and averages on the order of 170-180. Meanwhile, in the higher-dimensional FPA loop j=2, conditioning remains relatively unchanged for varying initial conditions x₀∈Gₓ_{₀} when lift ν_{L} and drag ν_{D} coefficient modeling errors are introduced, maxing in the range 260-300 and averaging in the range 240-290 regardless of the modeling error severity. Meanwhile, conditioning degradation in this loop j=2 is more pronounced with respect to pitch moment coefficient modeling error [symbol] , the worst-case over the IC grid increasing from 293.50 nominally to 728.94 at 25% modeling error. However, conditioning on this order (<10³) is a significant improvement from existing ADP-based CT-RL control algorithms, for which prior known techniques exhibit conditioning on the order of 10¹⁶ for HSV systems and 10¹¹ for academic second-order single input examples. Lastly, even though the conditioning degradation is more pronounced in the FPA loop j=2, this loop exhibits the lowest numerical sensitivity with respect to varying initial conditions x₀∈Gₓ_{₀}, as IC standard deviations for conditioning in this loop remain less than 10 regardless of the modeling error tested.

FIG. 12 depicts Table 5, set forth at element 1205, summarizing the dEIRL optimality error and conditioning data due to ablations of modeling error ν, in accordance with aspects of the disclosure. In particular, FIG. 12 depicts performance metrics 1206, summarizing the dEIRL controller-optimality error and algorithm-conditioning characteristics under ablations of modeling-error parameters ν, in accordance with aspects of the disclosure. Table 1205 presents worst-case, average, and standard-deviation values of the controller-parameter error ∥K_{i,1}−K₁*∥ and ∥K_{i,2}−K₂* ∥ for the velocity loop j=1 and the flight-path-angle loop j=2, respectively, together with corresponding percentage-reduction values from the initial stabilizing controller K_{0,j} to the learned controller K_{i*,j}. Table 1205 further reports the worst-iteration conditioning values associated with max; κ(A_{i,1}) and maxi κ(A_{i,2}), which characterize the numerical informativeness of the trajectory data used to form the decentralized learning regressions. The entries of Table 1205 are organized over the modeling-error grids Gν of Equation (20) and provide quantitative evaluations for lift/drag (L/D), lift/moment (L/M), and drag/moment (D/M) modeling-error combinations. Collectively, the data shown in Table 1205 illustrates the degree to which dEIRL recovers solution optimality in both control loops while maintaining well-conditioned learning behavior across the tested modeling-error directions and magnitudes.

FIGS. 13A, 13B, 13C, 13D, 13E, and 13F depict charts showing the dEIRL controller optimality error

$$‖ {K}_{{i}^{*} , 1} - {K}_{1}^{*} ‖$$

anu worst conditioning

$${max}_{i} κ ( {A}_{i , 1} )$$

for various simultaneous modeling errors, in accordance with aspects of the disclosure. In particular, FIGS. 13A-13F depict controller optimality error surface 1301, controller optimality error surface 1302, controller optimality error surface 1303, max conditioning surface 1304, max conditioning surface 1305, and max conditioning surface 1306, respectively, each illustrating dEIRL controller-optimality error ∥Kᵢ₁−K₁∥ and iterationwise maximum conditioning maxᵢ κ(A_{i,1}) over simultaneous variations in modeling-error parameters ν. Controller optimality error surface 1301, controller optimality error surface 1302, and controller optimality error surface 1303 visualize the learned controller-parameter deviation ∥Kᵢ₁−K₁∥ under paired variations in lift-coefficient ν^{L} and drag-coefficient ν^{D}, lift-coefficient ν^{L} and pitch-moment-coefficient ν^{M}, and drag-coefficient ν_{D} and pitch-moment-coefficient ν^{M}, respectively. Max conditioning surface 1304, max conditioning surface 1305, and max conditioning surface 1306 visualize corresponding conditioning characteristics maxᵢ κ(A_{i,1}) for the same modeling-error pairings.

Performance of dEIRL: Modeling Error-Ablation Study: HSV framework 170 was utilized to run dEIRL for simultaneous modeling errors ranging from 0-25% in lift/drag over the grid G_{ν}=G_{ν}_{_{L}}×G_{ν}_{_{D}}, lift/pitch moment G_{ν}=G_{ν}_{_{L}}× [symbol] , and drag/pitch moment G_{ν}=G_{ν}_{_{D}}× [symbol] when initialized at trim ICsx₀=xₑ, resulting in a total of 361 independent learning trials. Table 5 (see FIG. 12) displays the nominal controller optimality error

$$‖ {K}_{0 , j} - {K}_{j}^{*} ‖ ,$$

dEIRL's optimally error

$$‖ {K}_{{i}^{*} , j} - {K}_{j}^{*} ‖ ,$$

and the percent reduction in optimality error from nominal→dEIRL in each loop j=1 (velocity V), j=2 (FPA γ), as well as dEIRL's iterationwise maximum learning regression conditioning

$${max}_{i} κ ( {A}_{i , j} ) , j = 1 , 2.$$

All performance measures include worst, average, and standard deviation data (each taken over the respective 0-25% modeling error grids tested ν∈G_{ν}). The controller optimality error and conditioning data presented in Table 4 (see FIG. 9) are visually plotted in FIGS. 13A-13F for the velocity loop j=1.

Solution Optimality Generalization: Learning by dEIRL generalizes robustly with respect to severe and simultaneous modeling errors, achieving a percent reduction in controller optimality error relative to the nominal LQR design of at least 88.29% in the velocity loop j=1 and at least 73.67% in the FPA loop j=2 regardless of the modeling error type and severity. For simultaneous lift/drag modeling errors, optimality error from

$$‖ {K}_{0 , j} - {K}_{j}^{*} ‖ \to ‖ {K}_{{i}^{*} , j} - {K}_{j}^{*} ‖$$

(i.e., from nominal→dEIRL) averages 1.23→0.05 (95.63% reduction) in the velocity loop j=1, and 12.75→0.123 (99.05% reduction) in the FPA loop j=2. Similar average reductions are observed for the simultaneous lift/pitch moment and drag/pitch moment modeling error ablations. Meanwhile, the worst-case (i.e., smallest) reduction in optimality error across the board occurs in the higher-dimensional, unstable, nonminimum phase FPA loop j=2 for simultaneous lift/pitch moment modeling error, at 73.67%. This still represents a significant reduction by a factor of ¾. Furthermore, the reduction averages 92.42% for this modeling error ablation with a standard deviation of only 4.90%, so the worst-case 73.67% is an outlier.

Algorithm Conditioning Generalization: Conditioning performance in the velocity loop j=1 exhibits little variation with respect to modeling error, varying from 95 to 101 in the worst case with a standard deviation of 2.64 or less for all ablations. Conditioning in the FPA loop j=2 s is more volatile, which, given the higher regression dimensionality and dynamic features, is to be expected. For the lift/drag ablation, conditioning remains low at a maximum of 289.66. Meanwhile, conditioning degradation is more pronounced for both of the ablations involving the pitch moment coefficient, i.e., the lift/pitch moment and drag/pitch moment sweeps. For the lift/pitch moment ablation, average conditioning remains low at 231.06; however, it reaches a worst-case of 698.40. Conditioning fares the worst for the drag/pitch moment ablation, averaging 365.64 and reaching 793.94 at maximum. However, relative to the existing ADP-based performance of ˜10¹⁶ for the system on the nominal model, these ablation results are significant for real-world flight control.

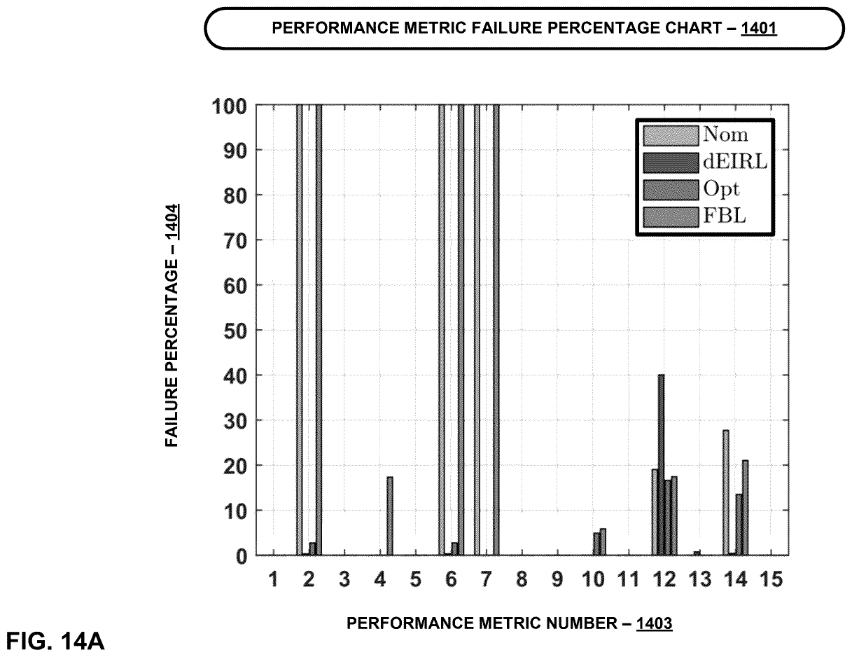

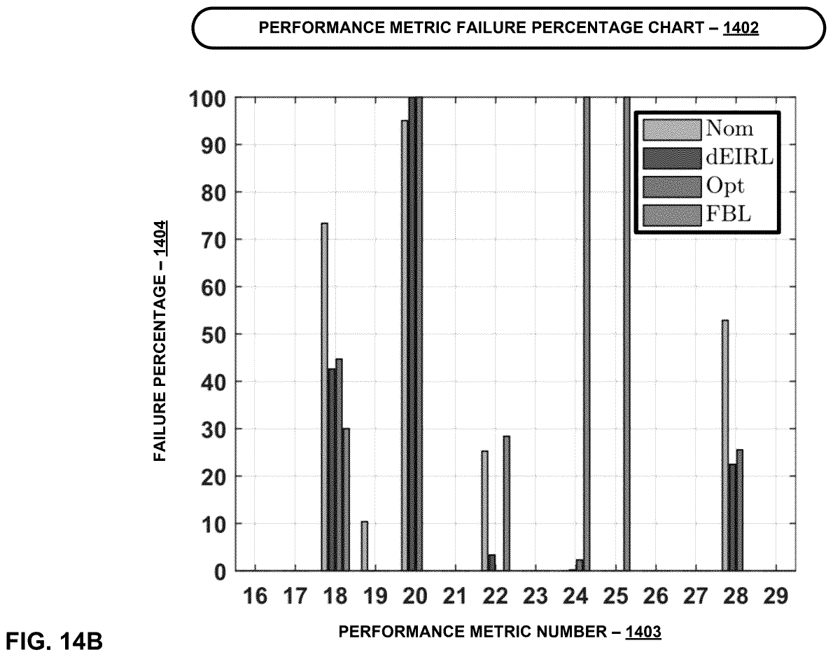

FIGS. 14A and 14B depict closed-loop performance metrics failure percentage, in accordance with aspects of the disclosure. In particular, FIGS. 14A and 14B depict performance metric failure percentage chart 1401 and performance metric failure percentage chart 1402, respectively. Performance metric failure percentage chart 1401 and performance metric failure percentage chart 1402 each include failure percentage 1404 along the vertical axis and performance metric number 1403 along the horizontal axis. Performance metric failure percentage chart 1401 visualizes closed-loop performance-metric failure percentages for velocity-command responses in loop V, and performance metric failure percentage chart 1402 visualizes closed-loop performance-metric failure percentages for flight-path-angle-command responses in loop γ. The closed-loop performance-metric failure percentages shown in performance metric failure percentage chart 1401 and performance metric failure percentage chart 1402 correspond to the definitions of the twenty-nine performance metrics set forth in Table 1 (see FIG. 4).

Closed-Loop Performance Robustness with Respect to Random Modeling Error: How often the methods meet the 29 closed-loop step response performance metrics defined in Table 1 (see FIG. 4) was statistically examined. Random modeling error was introduced simultaneously in each parameter: lift ν_{L} of Equation (4), drag ν_{D} of Equation (6), and pitch moment [symbol] of Equation (8). The test included 10,000 random trials of modeling error and the results were assembled to provide the failure percentages of each of the metrics in FIGS. 14A-14B.

Step Velocity Command: Firstly, all designs successfully stabilize the closed-loop system for the 10,000 random trials; i.e., each exhibits a failure rate of 0% in the stability metric I_{S} (metric 1). In comparison to the nominal LQR and FBL, dEIRL and the optimal LQR are 97% more likely to meet the tight 10% settling time (metric 2), while all designs achieve the less stringent 10% settling time (metric 3), and similar results hold for the 90% settling time (metrics 6 and 7). Meanwhile, for the 1% velocity settling time (metrics 4 and 5), all designs meet specification with the exception of FBL at a 17% failure rate on the tighter metric 4. All designs meet the percent overshoot specifications (metrics 8 and 9). For throttle control effort in metrics 10 and 11, all methods meet the specifications except for failure rates in the optimal LQR and FBL of 4.9% and 5.9%, respectively. The area where dEIRL struggles the most was in the more stringent elevator control effort specification (I_{V,δ}_{_{E}}_{0.25} metric 12, or a maximum 0.25 deg elevator deflection deviation), with a failure rate of 40%. By comparison, this is 21% higher than the nominal LQR (19%), 23.4% higher than the optimal LQR (16.6%), and 22.6% higher than FBL (17.4%). However, elevator deflections of 0.25 deg are small, and dEIRL meets the less stringent specification of 0.5 deg (metric 13) with only a 0.7% failure rate. Meanwhile, in FPA deviations as a result of issuing a step velocity command (metrics 14 and 15), dEIRL had a 27% less likelihood of failure than the nominal LQR, 13% less than the optimal LQR, and 21% less than FBL.

Step FPA Command: All designs performed well in the 10% FPA settling time specifications (metrics 16 and 17), each achieving a 0% failure rate. Meanwhile, for the 1% settling time specifications (metrics 18 and 19), dEIRL and the optimal LQR performed comparably in the stringent metric 18 (I_{γ,t}_{_{s,1}}%₁₀), failing at similar percentages of 42.6% and 44.7%, respectively. Comparatively, dEIRL is 31% less likely to fail metric 18 than the nominal LQR (73.4%) and 13% more likely than FBL (30%). Similarly, FBL far outperforms the nominal LQR, dEIRL, and the optimal in the stringent 90% FPA rise time metric 20. However, as a consequence of the fast rise/settling time, FBL exhibits the highest overshoot of the methods tested, with a failure rate of 28.4% in metric 22, compared to dEIRL and optimal LQR failure rates of 3.4% and 0%, respectively. This points to a statistical tradeoff between meeting rise/settling time and overshoot specifications when modeling error is introduced.

Another distinct tradeoff emerges between deviations in velocity due to a step FPA command (metrics 28 and 29) and the maximum throttle control exerted to mitigate the velocity deviation (metrics 24 and 25). On one hand, FBL achieves superior velocity deviation performance, with a failure rate of 0% in the more stringent deviation metric 28. This is followed by dEIRL (22.5%), the optimal LQR (25.5%, similar to dEIRL), and the nominal LQR (52.9%, highest). This performance characteristic of FBL was observed in the step response trials of above (refer again to FIGS. 8A-8F); fundamentally, they are a direct result of FBL's decoupling inversion of the system dynamics. However, FBL requires applying large throttle control δ_{T} in order to minimize the velocity dip transient caused by the FPA command (see FIG. 8E). As a result, FBL fails both throttle setting metrics 24 and 25 at a rate of 100%. By comparison, the largest failure rate for these metrics between the nominal LQR, dEIRL, and the optimal LQR is only 2.3% (by the optimal LQR on metric 24). Intuitively, allowable velocity deviations and throttle control effort must be traded off for issued FPA commands.

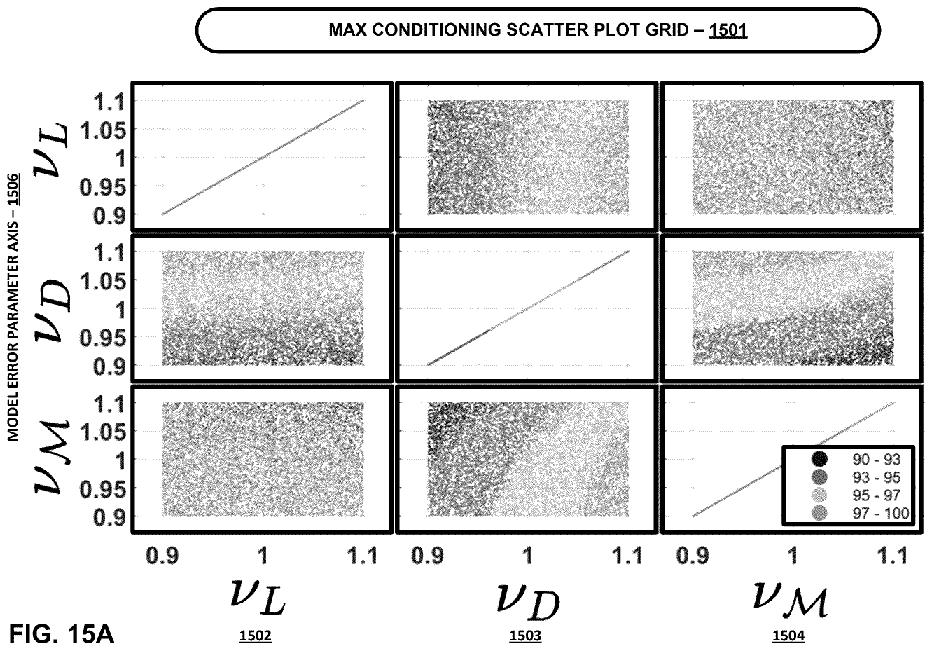

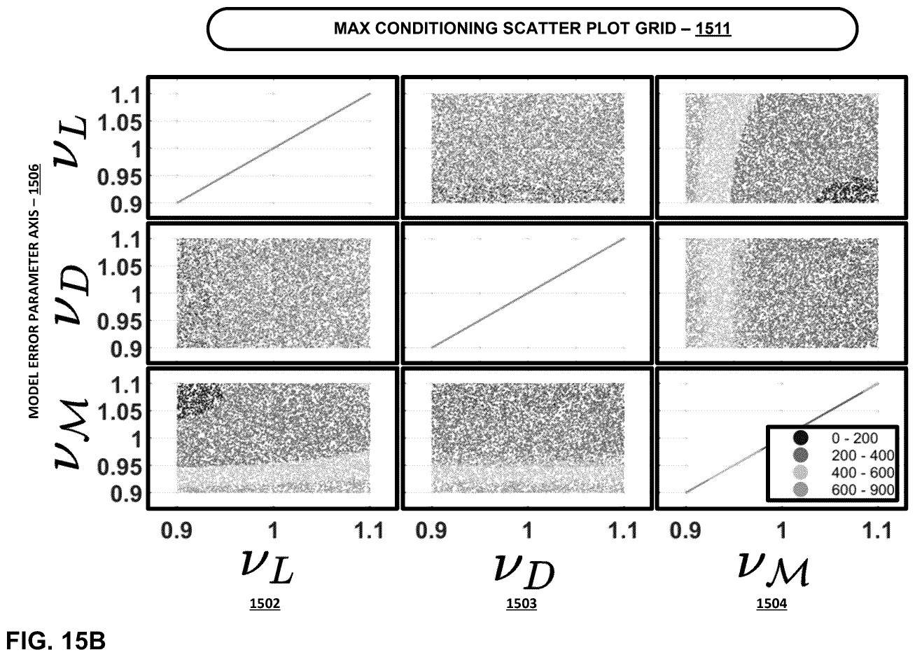

FIGS. 15A and 15B depict the dEIRL iterationwise maximum algorithm condition number

$${max}_{i} κ ( {A}_{i , j} )$$

for 10,000 trails of randomly distributed modeling error, in accordance with aspects of the disclosure. In particular, FIGS. 15A and 15B depict max conditioning scatter plot grid 1501 and max conditioning scatter plot grid 1511, respectively, in accordance with aspects of the disclosure. Max conditioning scatter plot grid 1501 and max conditioning scatter plot grid 1511 each include model error parameter axis 1506 arranged vertically and axis labels ν_{L} 1502, ν_{D} 1503, and [symbol] 1504 arranged horizontally to represent lift-uncertainty (1502), drag-uncertainty (1503), and pitch-moment-uncertainty (1504), respectively. Max conditioning scatter plot grid 1501 visualizes decentralized excitable integral reinforcement learning (dEIRL) iterationwise maximum algorithm conditioning values

$${max}_{i} κ ( {A}_{i , j} )$$

for 10,000 trials of randomly distributed modeling error for velocity-loop index j=1, and max conditioning scatter plot grid 1511 visualizes decentralized excitable integral reinforcement learning iterationwise maximum algorithm conditioning values

$${max}_{i} κ ( {A}_{i , j} )$$

for 10,000 trials of randomly distributed modeling error for flight-path-angle-loop index j=2.

Algorithm Conditioning Generalization: FIGS. 15A-15B show the maximum condition number

$${max}_{i} κ ( {A}_{i , j} )$$

for the 10,000 trials of randomly distributed modeling error conducted, providing a view of the effects grouped in two parameters at once. As can be seen, conditioning in the velocity loop j=1 is most heavily influenced by variations in drag coefficient ν_{D} and secondarily by pitch moment coefficient [symbol] . Meanwhile, in the FPA loop j=2, conditioning is most heavily influenced by variations in pitch moment coefficient [symbol] and secondarily by lift coefficient ν_{L}. These results are intuitive and are corroborated by those seen in the modeling error grid sweeps described above. Conditioning remains below 100 in the velocity loop j=1 and 900 in the FPA loop j=2, also comparable to the results discussed previously.

In such a way, hypersonic vehicle (HSV) framework 170 and the decentralized excitable integral reinforcement learning (dEIRL) framework variant provides a continuous-time reinforcement learning (CT-RL) framework for controlling hypersonic vehicles (HSVs). HSV framework 170 integrates a three-pronged approach, leveraging decentralization, multi-injection (MI), and modulation-enhanced excitation (MEE) to improve numerical stability during learning processes. HSV framework 170 includes comprehensive results, providing theoretical proof of convergence, solution optimality, and closed-loop stability. These features collectively ensure robust control in HSV applications.

To further substantiate HSV framework 170 and the dEIRL framework variant, a quantitative performance evaluation framework was utilized for reinforcement learning (RL) algorithms in HSV control. Results show that HSV framework 170 and the dEIRL variant consistently recovers an optimal controller, maintaining high performance even under conditions of considerable model uncertainty and diverse initial states. Notably, dEIRL reliably reproduces optimal closed-loop reference commands in response to operational performance demands, with statistical robustness when facing randomly distributed modeling errors.

The evaluation suite tested a comprehensive set of 35 learning and closed-loop design metrics across 12,872 independent learning trials, a significant increase in scope compared to prior HSV-focused RL control studies. Additionally, the performance of HSV framework 170 was compared against established classical methods, including decentralized linear quadratic (LQ) control and feedback linearization techniques. HSV framework 170 and the dEIRL framework variant demonstrated a superior ability to generalize closed-loop performance when confronted with model uncertainty, surpassing these traditional methods in resilience and adaptability.

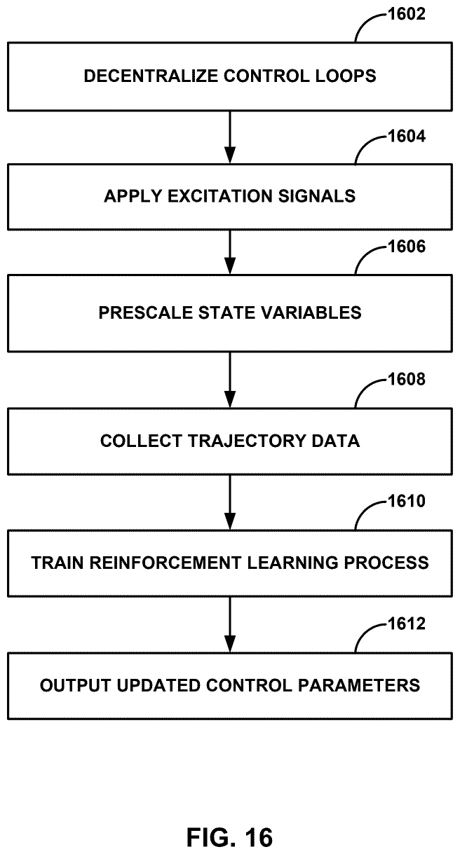

FIG. 16 is a flow diagram illustrating an example method for learning a control solution for a continuous-time affine-nonlinear aerospace system, in accordance with aspects of this disclosure. FIG. 16 is described with respect to computing device 100 of FIG. 1, including processor(s) 102, decomposer 175, decentralizer 180, prescaler 185, multi-injection module 190, reinforcement learning module 195, trajectory data collector 197, probing input generator 198, and updated control parameter output 199. However, the techniques of FIG. 16 may be performed by different components of computing device 100 or by additional or alternative systems configured to support decentralized learning, data-driven parameter adaptation, and control-solution refinement for aerospace platforms.

Processing circuitry of computing device 100 may be configured to decentralize control loops (1602). For example, decomposer 175 and decentralizer 180 may decentralize a control solution for the system into a plurality of lower-dimensional control loops based on a partition of system dynamics.

Processing circuitry of computing device 100 may be configured to apply excitation signals (1604). For example, multi-injection module 190 and probing input generator 198 may apply excitation signals to the system, the excitation signals including reference-command variations and probing inputs that can increase persistence of excitation during learning.

Processing circuitry of computing device 100 may be configured to prescale state variables (1606). For example, prescaler 185 may perform a prescaling transformation of state variables, the prescaling transformation being configured to modify conditioning properties of a learning regression associated with the decentralized control loops.

Processing circuitry of computing device 100 may be configured to collect trajectory data (1608). For example, trajectory data collector 197 may collect trajectory data resulting from operation of the system under the applied excitation signals and generate learning data for the decentralized control loops.

Processing circuitry of computing device 100 may be configured to train reinforcement learning process (1610). For example, reinforcement learning module 195 may train a reinforcement learning control process that performs integral value-function updates based on trajectory data using the learning data to obtain updated control parameters.

Processing circuitry of computing device 100 may be configured to output updated control parameters (1612). For example, updated control parameter output 199 may provide the updated control parameters as a learned control solution for the system.

In this way, FIG. 16 illustrates a method for learning a control solution for a nonlinear aerospace system through decentralized control-loop structuring, excitation-based data collection, conditioning-aware prescaling, and reinforcement-learning-driven parameter updating, enabling generation of refined control parameters suitable for improved guidance and control performance across varied operating conditions.

Examples of the various aspects of this disclosure may be used individually or in any combination. Additional aspects of the disclosure are detailed in numbered clauses below.

Clause 1—A method for learning a control solution for a continuous-time affine-nonlinear aerospace system, the method comprising: decentralizing a control solution for the system into a plurality of lower dimensional control loops based on a partition of system dynamics; applying excitation signals to the system, the excitation signals comprising reference-command variations and probing inputs configured to increase persistence of excitation during learning; selectively performing a prescaling transformation of state variables, the prescaling transformation configured to modify conditioning properties of a learning regression associated with the decentralized control loops; collecting trajectory data from operation of the system under the applied excitation signals and generating learning data for the decentralized control loops; training a reinforcement learning control process that performs integral value-function updates based on trajectory data using the learning data to obtain updated control parameters; and outputting the updated control parameters as a learned control solution for the system.

Clause 2—The method of any of Clauses 1, wherein training the reinforcement learning control process comprises updating a set of controller parameters to approximate linear quadratic control behavior and to improve closed-loop stability and robustness.

Clause 3—The method of any of Clauses 1-2, wherein training the reinforcement learning control process comprises determining critic weights for a value function represented as V(x)=V₁(x₁)+V₂(x₂), each of V₁ and V₂ comprising a quadratic form of state variables associated with a corresponding decentralized control loop.

Clause 4—The method of any of Clauses 1-3, wherein the system comprises an aerospace vehicle with nonminimum phase dynamics.

Clause 5—The method of any of Clauses 1-4, wherein the aerospace vehicle comprises a hypersonic vehicle.

Clause 6—The method of any of Clauses 1-5, wherein the reinforcement learning control process adapts control parameters with respect to lift uncertainty ν_{L}, drag uncertainty VD, and pitch moment uncertainty [symbol] of the hypersonic vehicle.

Clause 7—The method of any of Clauses 1-6, wherein decentralizing the control solution comprises partitioning translational dynamics and rotational dynamics of the system into separate control loops.

Clause 8—The method of any of Clauses 1-7, wherein applying the excitation signals comprises injecting reference-command variations at an outer-loop input and injecting probing inputs at a plant input.

Clause 9—The method of any of Clauses 1-8, wherein performing the prescaling transformation comprises applying a nonsingular transformation to the state variables to generate prescaled state variables and to modify conditioning properties of the learning regression.

Clause 10—The method of any of Clauses 1-9, wherein collecting trajectory data comprises accumulating state and control samples over multiple time intervals and computing integral expressions of the trajectory data for each decentralized control loop.

Clause 11—The method of any of Clauses 1-10, wherein selecting the prescaling transformation comprises evaluating a conditioning metric of the learning regression.

Clause 12—The method of any of Clauses 1-11, further comprising forming the learning regression using the integral expressions and the prescaled state variables.

Clause 13—The method of any of Clauses 1-12, wherein training the reinforcement learning control process comprises solving the learning regression to determine critic weights associated with each decentralized control loop.

Clause 14—The method of any of Clauses 1-13, wherein outputting the updated control parameters comprises generating throttle and attitude control commands for the system.

Clause 15—A system for learning a control solution for a continuous-time affine-nonlinear aerospace vehicle (vehicle), the system comprising: at least one memory configured to store instructions; and processing circuitry configured to execute the instructions to: decentralize a control solution for the vehicle into a plurality of lower dimensional control loops based on a partition of vehicle dynamics; apply excitation signals to the vehicle, the excitation signals comprising reference-command variations and probing inputs configured to increase persistence of excitation during learning; selectively perform a prescaling transformation of state variables, the prescaling transformation configured to modify conditioning properties of a learning regression associated with the decentralized control loops; collect trajectory data from operation of the vehicle under the applied excitation signals and generate learning data for the decentralized control loops; train a reinforcement learning control process that performs integral value-function updates based on trajectory data using the learning data to obtain updated control parameters; and output the updated control parameters as a learned control solution for the vehicle.

Clause 16—The system of any of Clauses 15, wherein the processing circuitry is further configured to update controller parameters to approximate linear quadratic control behavior and to improve closed-loop stability and robustness.

Clause 17—The system of any of Clauses 15-16, wherein the processing circuitry is further configured to determine critic weights for a value function represented as V(x)=V₁(x₁)+V₂(x₂), each of V₁ and V₂ comprising a quadratic form of state variables associated with a corresponding decentralized control loop.

Clause 18—The system of any of Clauses 15-17, wherein the vehicle comprises a hypersonic vehicle, and wherein the processing circuitry is further configured to adapt control parameters with respect to lift uncertainty νₗ, drag uncertainty ν_{L}, drag uncertainty ν_{D}, and pitch moment uncertainty [symbol] of the hypersonic vehicle.

Clause 19—The system of any of Clauses 15-18, wherein the processing circuitry is further configured to form the learning regression using integral expressions of trajectory data and state variables that have undergone the prescaling transformation and to solve the learning regression to determine critic weights for the decentralized control loops.

Clause 20—A non-transitory computer-readable medium storing instructions that, when executed by processing circuitry, cause the processing circuitry to: decentralize a control solution for a continuous-time affine-nonlinear aerospace vehicle into a plurality of lower dimensional control loops based on a partition of system dynamics; apply excitation signals to the vehicle comprising reference-command variations and probing inputs configured to increase persistence of excitation during learning; perform a prescaling transformation of state variables to modify conditioning properties of a learning regression; collect trajectory data and generate learning data for the decentralized control loops; train a reinforcement learning control process that performs integral value-function updates based on trajectory data using the learning data to obtain updated control parameters; and output the updated control parameters as a learned control solution for the vehicle.

Clause 21—A computer program product comprising one or more instructions that, when executed by at least one processor, cause the at least one processor to perform any of the methods of clauses 1-14.

Clause 22—A device comprising means for performing any of the methods of clauses 1-14.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with the examples of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

What is claimed is:

1. A method for learning a control solution for a continuous-time affine-nonlinear aerospace system, the method comprising:
decentralizing a control solution for the system into a plurality of lower dimensional control loops based on a partition of system dynamics;
applying excitation signals to the system, the excitation signals comprising reference-command variations and probing inputs configured to increase persistence of excitation during learning;
selectively performing a prescaling transformation of state variables, the prescaling transformation configured to modify conditioning properties of a learning regression associated with the decentralized control loops;
collecting trajectory data from operation of the system under the applied excitation signals and generating learning data for the decentralized control loops;
training a reinforcement learning control process that performs integral value-function updates based on trajectory data using the learning data to obtain updated control parameters; and
outputting the updated control parameters as a learned control solution for the system.

2. The method of claim 1, wherein training the reinforcement learning control process comprises updating a set of controller parameters to approximate linear quadratic control behavior and to improve closed-loop stability and robustness.

3. The method of claim 1, wherein training the reinforcement learning control process comprises determining critic weights for a value function represented as V(x)=V₁(x₁)+V₂(x₂), each of V₁ and V₂ comprising a quadratic form of state variables associated with a corresponding decentralized control loop.

4. The method of claim 1, wherein the system comprises an aerospace vehicle with nonminimum phase dynamics.

5. The method of claim 4, wherein the aerospace vehicle comprises a hypersonic vehicle.

6. The method of claim 5, wherein the reinforcement learning control process adapts control parameters with respect to lift uncertainty ν_{L}, drag uncertainty ν_{D}, and pitch moment uncertainty [symbol] of the hypersonic vehicle.

7. The method of claim 1, wherein decentralizing the control solution comprises partitioning translational dynamics and rotational dynamics of the system into separate control loops.

8. The method of claim 1, wherein applying the excitation signals comprises injecting reference-command variations at an outer-loop input and injecting probing inputs at a plant input.

9. The method of claim 1, wherein performing the prescaling transformation comprises applying a nonsingular transformation to the state variables to generate prescaled state variables and to modify conditioning properties of the learning regression.

10. The method of claim 9, wherein collecting trajectory data comprises accumulating state and control samples over multiple time intervals and computing integral expressions of the trajectory data for each decentralized control loop.

11. The method of claim 9, wherein selecting the prescaling transformation comprises evaluating a conditioning metric of the learning regression.

12. The method of claim 11, further comprising forming the learning regression using the integral expressions and the prescaled state variables.

13. The method of claim 1, wherein training the reinforcement learning control process comprises solving the learning regression to determine critic weights associated with each decentralized control loop.

14. The method of claim 13, wherein outputting the updated control parameters comprises generating throttle and attitude control commands for the system.

15. A system for learning a control solution for a continuous-time affine-nonlinear aerospace vehicle (vehicle), the system comprising:
at least one memory configured to store instructions; and
processing circuitry configured to execute the instructions to:
decentralize a control solution for the vehicle into a plurality of lower dimensional control loops based on a partition of vehicle dynamics;
apply excitation signals to the vehicle, the excitation signals comprising reference-command variations and probing inputs configured to increase persistence of excitation during learning;
selectively perform a prescaling transformation of state variables, the prescaling transformation configured to modify conditioning properties of a learning regression associated with the decentralized control loops;
collect trajectory data from operation of the vehicle under the applied excitation signals and generate learning data for the decentralized control loops;
train a reinforcement learning control process that performs integral value-function updates based on trajectory data using the learning data to obtain updated control parameters; and
output the updated control parameters as a learned control solution for the vehicle.

16. The system of claim 15, wherein the processing circuitry is further configured to update controller parameters to approximate linear quadratic control behavior and to improve closed-loop stability and robustness.

17. The system of claim 15, wherein the processing circuitry is further configured to determine critic weights for a value function represented as V(x)=V₁(x₁)+V₂(x₂), each of V₁ and V₂ comprising a quadratic form of state variables associated with a corresponding decentralized control loop.

18. The system of claim 15, wherein the vehicle comprises a hypersonic vehicle, and wherein the processing circuitry is further configured to adapt control parameters with respect to lift uncertainty ν_{L}, drag uncertainty ν_{D}, and pitch moment uncertainty [symbol] of the hypersonic vehicle.

19. The system of claim 15, wherein the processing circuitry is further configured to form the learning regression using integral expressions of trajectory data and state variables that have undergone the prescaling transformation and to solve the learning regression to determine critic weights for the decentralized control loops.

20. A non-transitory computer-readable medium storing instructions that, when executed by processing circuitry, cause the processing circuitry to:
decentralize a control solution for a continuous-time affine-nonlinear aerospace vehicle into a plurality of lower dimensional control loops based on a partition of system dynamics;
apply excitation signals to the vehicle comprising reference-command variations and probing inputs configured to increase persistence of excitation during learning;
selectively perform a prescaling transformation of state variables to modify conditioning properties of a learning regression;
collect trajectory data and generate learning data for the decentralized control loops;
train a reinforcement learning control process that performs integral value-function updates based on trajectory data using the learning data to obtain updated control parameters; and
output the updated control parameters as a learned control solution for the vehicle.
